(19) United States
(12) Patent Application Publication
(10) Pub. No.: US 2025/0358443 A1
(43) Pub. Date: Nov. 20, 2025

(54) METHODS AND DEVICES FOR FILTERED INTRA BLOCK COPY, INTRA BLOCK COPY AND INTRA TEMPLATE MATCHING

(71) Applicant: BEIJING DAJIA INTERNET INFORMATION TECHNOLOGY CO., LTD., Beijing (CN)

(72) Inventors: Hong-Jheng JHU, San Diego, CA (US); Che-Wei KUO, San Diego, CA (US); Xiaoyu XIU, San Diego, CA (US); Ning YAN, San Diego, CA (US); Wei CHEN, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/284,961

(22) Filed: Jul. 30, 2025

Related U.S. Application Data
(63) Continuation of application No. PCT/US2024/013278, filed on Jan. 29, 2024.
(63) Continuation of application No. PCT/US2024/014368, filed on Feb. 3, 2024.
(60) Provisional application No. 63/482,114, filed on Jan. 30, 2023.
(60) Provisional application No. 63/443,322, filed on Feb. 3, 2023.

(51) Int. Cl. H04N 19/593; H04N 19/105; H04N 19/117; H04N 19/176; H04N 19/186

(52) U.S. Cl. CPC H04N 19/593; H04N 19/105; H04N 19/117; H04N 19/176; H04N 19/186

(57) ABSTRACT

A method for decoding video data, including determining a reference block in a video frame from a bitstream for predicting a current block in the video frame, obtaining a set of filter coefficients corresponding to a filter shape based on the sample values from both a training area associated with the reference block and a training area associated with the current block, deriving, with the set of filter coefficients and the filter shape, each of predicted sample values of the current block based on a plurality of corresponding sample values associated with the reference block, and reconstructing the current block based on the predicted sample values.

### CROSS-REFERENCE TO RELATED APPLICATION

This application is a continuation application of PCT Applications No. PCT/US2024/013278 filed on Jan. 29, 2024 based upon and claiming priority to Provisional Application No. 63/482,114 filed on Jan. 30, 2023, and No. PCT/US2024/014368 filed on Feb. 3, 2024 based upon and claiming priority to Provisional Application No. 63/443,322 filed on Feb. 3, 2023. The entire contents thereof are incorporated herein by reference in their entireties.

### TECHNICAL FIELD

This application is related to video coding and compression. More specifically, this application relates to methods and apparatus on improving the coding efficiency of filtered intra block copy (FIBC), intra block copy (IBC) and intra template matching prediction (Intra TMP).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide methods and apparatus on improving the coding efficiency of the image/video blocks which applies FIBC technology.

According to the embodiments of this disclosure, fractional-pel intra block copy is proposed to further improve the prediction accuracy of the FIBC mode.

According to the embodiments of this disclosure, multi-hypothesis FIBC methods are provided to exploit multiple hypothesis to generate the final prediction block by using fixed weighting factors.

According to the embodiments of this disclosure, multi-hypothesis FIBC methods are provided to exploit multiple hypothesis to generate the final prediction block by using adaptive weighting factors.

According to one aspect of the present disclosure, there is provided a method for decoding video data, comprising: determining a reference block in a video frame from a bitstream for predicting a current block in the video frame; obtaining a set of filter coefficients corresponding to a filter shape based on the sample values from both a training area associated with the reference block and a training area associated with the current block; deriving, with the set of filter coefficients and the filter shape, each of predicted sample values of the current block based on a plurality of corresponding sample values associated with the reference block; and reconstructing the current block based on the predicted sample values.

According to one aspect of the present disclosure, there is provided a method for encoding video data, comprising: determining a reference block in a video frame for predicting a current block in the video frame; obtaining a set of filter coefficients corresponding to a filter shape based on the sample values from both a training area associated with the reference block and a training area associated with the current block; deriving, with the set of filter coefficients and the filter shape, each of predicted sample values of the current block based on a plurality of corresponding sample values associated with the reference block; and generating a bitstream based on the predicted sample values.

According to one aspect of the present disclosure, there is provided a non-transitory computer readable storage medium storing a bitstream to be decoded by the decoding method according to the method of the present disclosure.

According to one aspect of the present disclosure, there is provided a non-transitory computer readable storage medium storing a bitstream generated by the encoding method according to the method of the present disclosure.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A, 4B, 4C, 4D and 4E are block diagrams illustrating how a frame is recursively partitioned into multiple video blocks of different sizes and shapes in accordance with some implementations of the present disclosure.

FIG. 5 illustrates a diagram of positions of spatial candidates.

FIG. 6 illustrates a diagram of candidate pairs considered for redundancy check of spatial candidates.

FIG. 7 illustrates a diagram of scaling of a motion vector for a temporal candidate.

FIG. 8 illustrates a diagram of candidate positions for a temporal candidate.

FIG. 9 illustrates a diagram of Merge mode with Motion Vector Difference (MMVD) search points.

FIG. 10 illustrates uni-prediction motion vector selection for Geometric Partitioning Mode (GPM).

FIG. 11 illustrates top and left neighboring blocks used in CIIP weight derivation.

FIG. 12 illustrates current CTU processing order and its available reference samples in current and left CTU.

FIG. 13 illustrates padding candidates for the replacement of the zero-vector in the IBC list.

FIG. 14 illustrates reference area for IBC when CTU (m,n) is coded.

FIG. 15 illustrates IBC reference area for camera-captured content.

FIGS. 16A to 16B illustrate the division method for angular modes.

FIGS. 17A, 17B and 17C illustrate available IPM candidates and FIG. 17D illustrates an example of GPM with intra and intra prediction.

FIG. 18 illustrates the edge on templates.

FIG. 19 illustrates the intra template matching search area used.

FIG. 20 illustrates the template used for template matching based OBMC.

FIG. 21 illustrates the division method and corresponding weights for intra coded block for angular and planar modes.

FIG. 22 illustrates a diagram of the filter shape and training area of the reference block.

FIG. 23 illustrates a diagram of spatial terms correspond to neighboring luma samples.

FIG. 24 illustrates a diagram of examples of different shape/number of filter taps.

FIG. 25 illustrates a diagram of possible positions of candidate regions.

FIG. 26 illustrates a diagram of possible positions of candidates.

FIG. 27 illustrates a workflow of a method for decoding video data according to one or more aspects of the present disclosure.

FIG. 28 illustrates a workflow of a method for encoding video data according to one or more aspects of the present disclosure.

FIG. 29 is a diagram illustrating a computing environment coupled with a user interface, according to some implementations of the present disclosure.

FIG. 30 illustrates a workflow of a method for decoding video data according to one or more aspects of the present disclosure.

FIG. 31 illustrates a workflow of a method for encoding video data according to one or more aspects of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

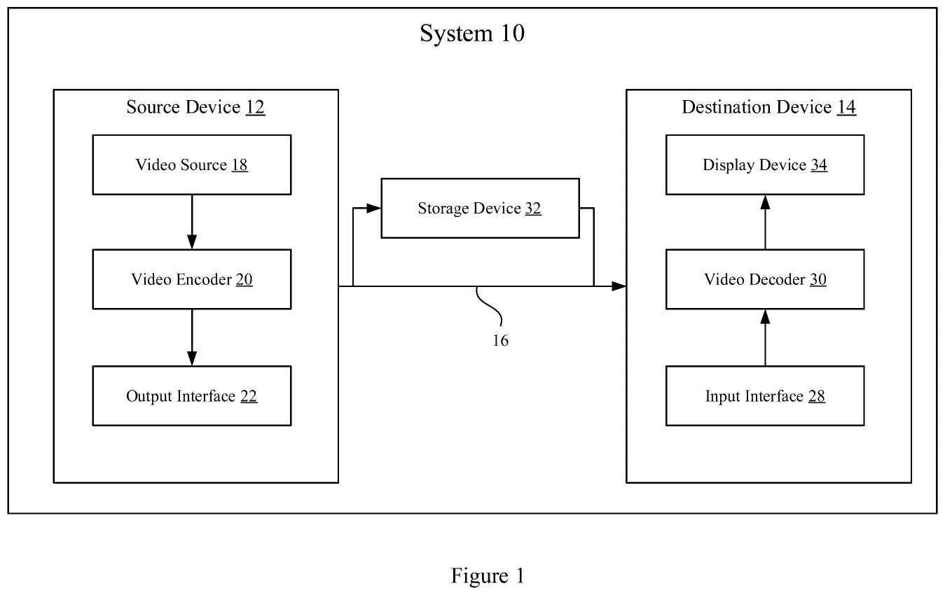

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

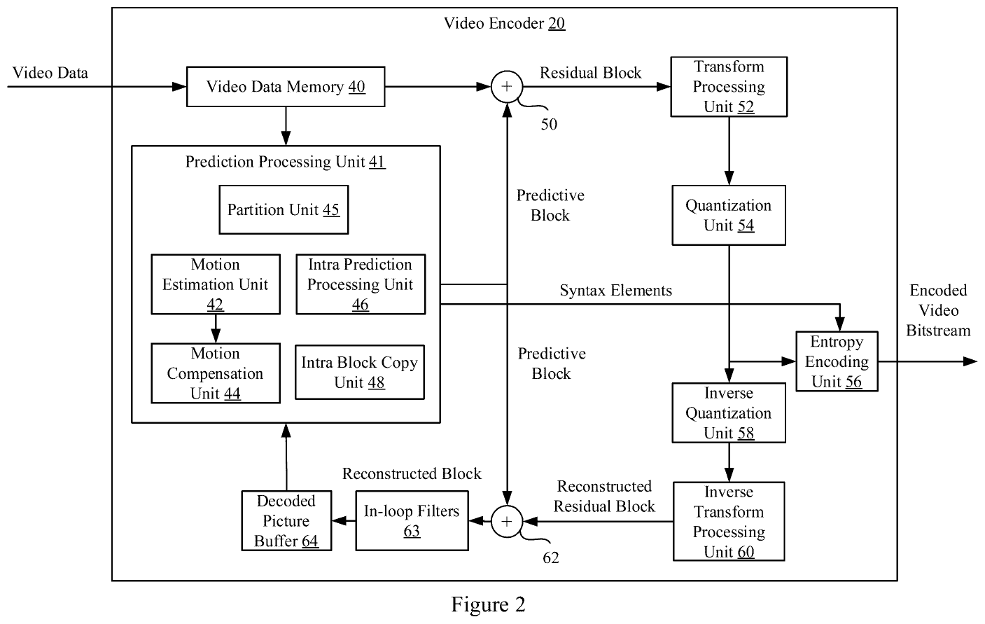

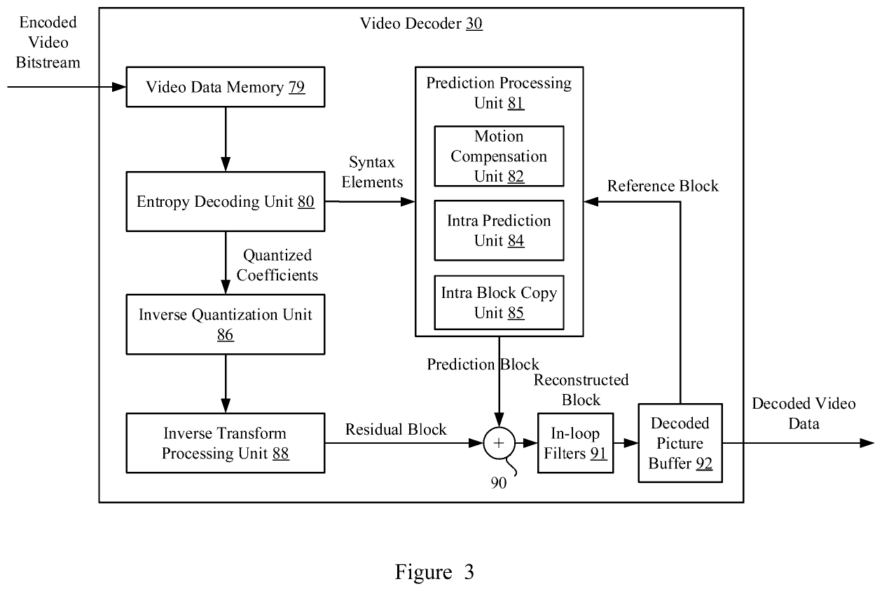

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

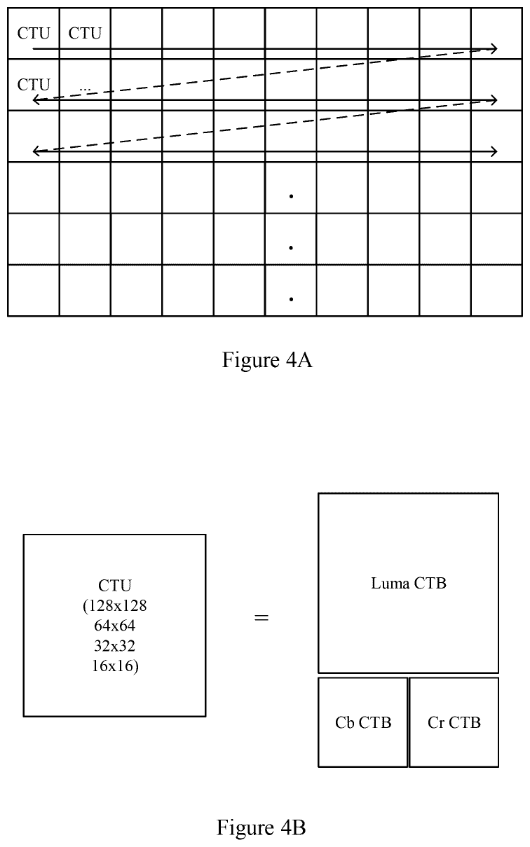

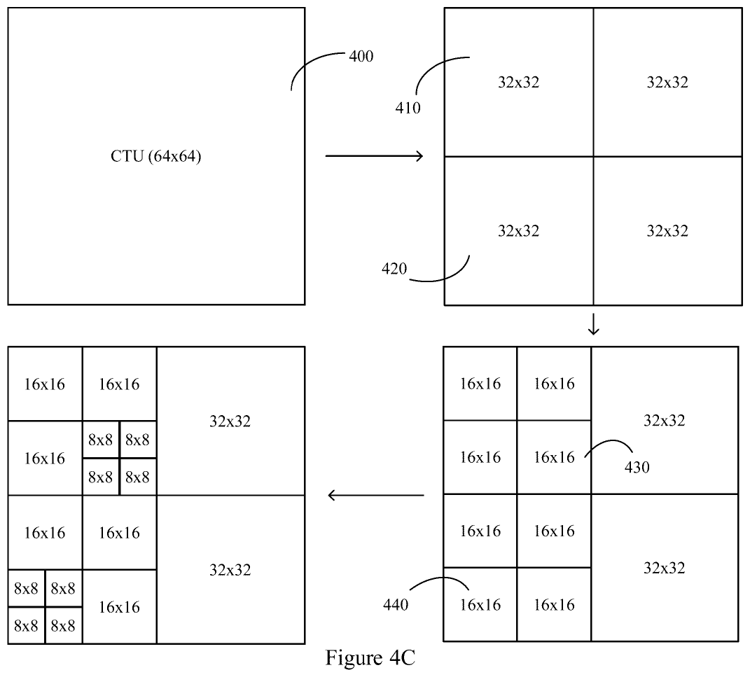

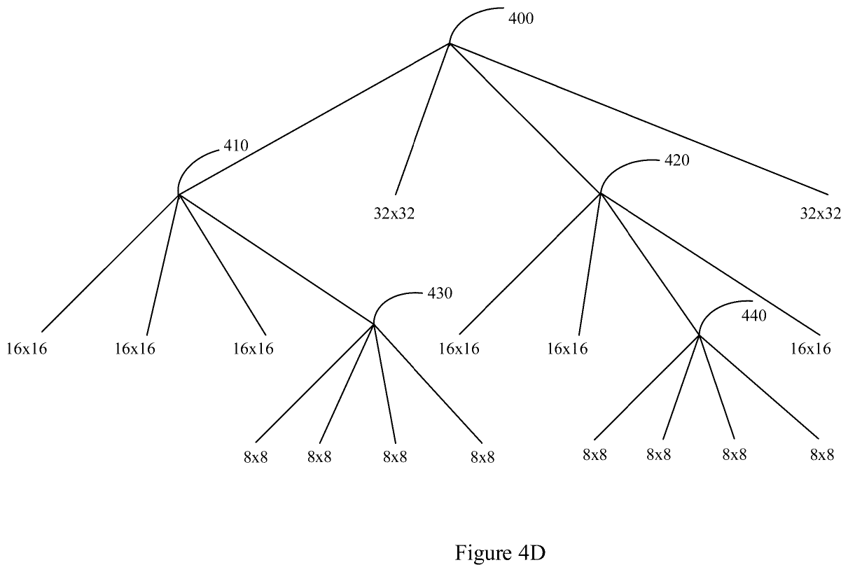

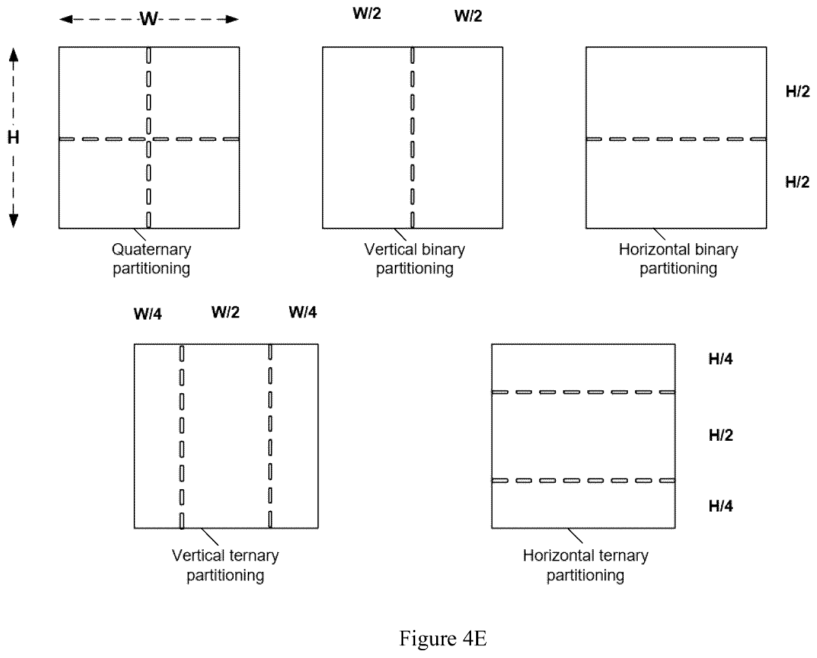

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

In general, the basic inter prediction scheme applied in VVC is almost kept the same as that of HEVC, except that several prediction tools are further extended, added and/or improved, e.g., extended merge prediction, MMVD, and GPM.

### Extended Merge Prediction

With the ever improving video data capturing technology and more refined video block size for preserving details in the video data, an amount of data required for representing motion vectors for a current picture also increases substantially. One way of overcoming this challenge is to use motion information (e.g., a motion vector) of a spatially neighboring CU, a temporally collocated CU etc. of a current CU as an approximation (e.g., prediction) of motion information of the current CU, which is also referred to as “Motion Vector Predictor (MVP)” of the current CU. The “motion vectors” used throughout the present disclosure comprise not only the motion vectors between CUs from different frames (e.g., between temporally collocated CUs in inter prediction) but also the block vectors between CUs in the same frame (e.g., between spatially neighboring CUs in intra prediction).

Like a process of choosing a predictive block in a reference picture during inter-prediction of a coding block, a set of rules need to be adopted by both the video encoder 20 and the video decoder 30 for constructing an MVP candidate list for a current CU and then selecting one MVP candidate from the MVP candidate list as an MVP for the current CU. By doing so, there is no need to transmit the MVP candidate list itself between the video encoder 20 and the video decoder 30, and an index of the MVP candidate selected from the MVP candidate list is sufficient for the video encoder 20 and the video decoder 30 to use the same MVP candidate selected from the MVP candidate list for encoding and decoding the current CU.

In VVC, the MVP candidate list is constructed by including the following five types of MVPs in order:
Spatial MVP from spatially neighboring CUs (i.e., spatial candidates);
Temporal MVP from temporally collocated CUs (i.e., temporal candidates);
History-based MVP (HMVP) from a First-In-First-Out (FIFO) table;
Pairwise average MVP; and
Zero MVPs.

A size of the MVP candidate list is signalled in a sequence parameter set header and a maximum allowed size of the MVP candidate list is 6. For each CU coded in merge mode, an index of the best MVP candidate is encoded using truncated unary binarization. A first bin of the index is coded with contexts and bypass coding is used for other bins of the index.

A derivation process of each type of MVPs is provided as follows. As in HEVC, VVC also supports parallel derivation of MVP candidate lists for all CUs within a certain size of area.

Derivation of MVPs from Spatial Candidates

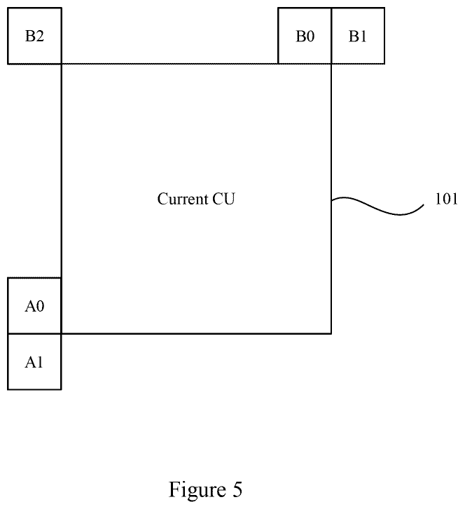

The derivation of MVPs from spatial candidates (for example, CUs neighboring a current CU 101 in FIG. 5) in VVC is the same as that in HEVC except that positions of first two spatial candidates are swapped. A maximum of four spatial candidates are selected from spatial candidates located at positions depicted in FIG. 5, that is, a top position B0, a left position A0, a top-right position B1, a bottom-left position A1 and a top-left position B2. The derivation is performed in an order of CUs at the positions B0, A0, B1, A1 and B2. A CU at the position B2 is considered only when one or more CUs at the positions B0, A0, B1 and A1 are not available (for example, because said one or more CUs belong to other slices or tiles) or is intra coded.

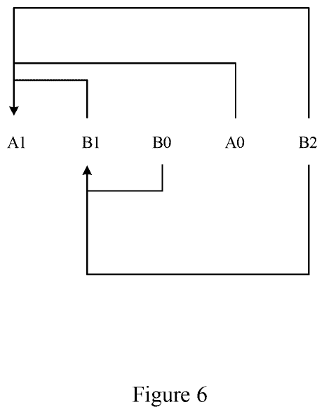

After a CU at the position B0 is added as a candidate to a merge candidate list, the addition of the remaining candidates to the merge candidate list is subject to redundancy check, which ensures that candidates with the same motion information are excluded from the merge candidate list, so that coding efficiency is improved. To reduce computational complexity, not all possible candidate pairs are considered in the redundancy check. Instead, only pairs linked using a line with an arrow in FIG. 6 are considered and a candidate is added to the merge candidate list only if a candidate in a corresponding pair used for the redundancy check has not the same motion information as that of the candidate to be added. Spatial MVPs derived from the candidates in the merge candidate list are added to the MVP candidate list.

Derivation of MVPs from Temporal Candidates

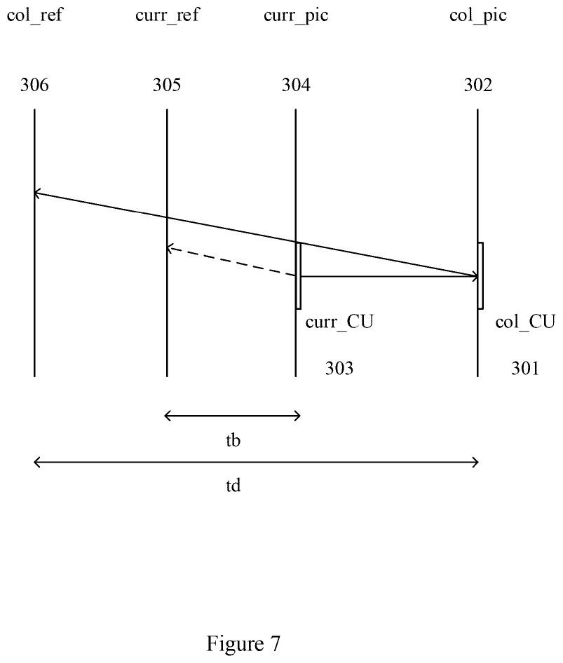

During the derivation of MVPs from temporal candidates, only one temporal candidate is added to the merge candidate list. Particularly, in the derivation of an MVP from this temporal candidate, a scaled motion vector is derived based on a collocated CU (for example, col_CU 301 in FIG. 7) as the temporal candidate belonging to a collocated picture (for example, col_pic 302 in FIG. 7) for a current CU (for example, curr_CU 303 in FIG. 7), and is added as a temporal MVP candidate to the MVP candidate list. A reference picture list and a reference picture index to be used for derivation of the collocated CU are explicitly signalled in a slice header. The scaled motion vector is obtained (i.e., scaled) from a motion vector of the collocated CU using Picture Order Count (POC) distances, i.e., tb and td, as illustrated in FIG. 7, where tb is defined to be a POC difference between a reference picture (for example, curr_ref 305 in FIG. 7) of the current picture (for example, curr_pic 304 in FIG. 7) and the current picture and td is defined to be a POC difference between a reference picture (for example, col_ref 306 in FIG. 7) of the collocated picture and the collocated picture. A reference picture index of the temporal candidate is set equal to zero.

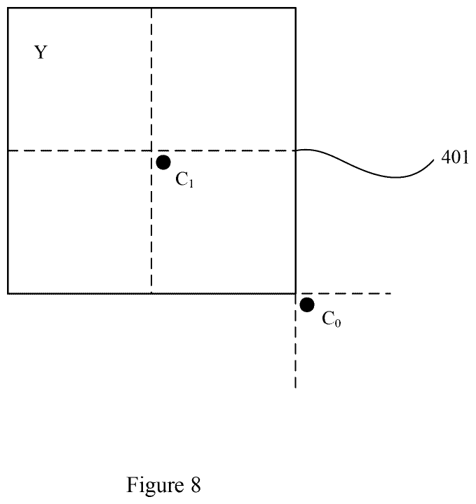

A position for the temporal candidate (i.e., the collocated CU) in the current CU 401 is selected between positions C₀ and C₁, as depicted in FIG. 8. If a CU at position C₀ in the collocated picture is not available, is intra coded, or is outside of a current row of CTUs, a CU at position C₁ is used as the collocated CU for the derivation of the temporal MVP candidate. Otherwise, a CU at position C₀ is used as the collocated CU for the derivation of the temporal MVP candidate.

### Derivation of HMVP Candidates

HMVP candidates are added to the MVP candidate list after the spatial MVPs and the temporal MVP. Motion information of a previously coded block is stored in an HMVP table and used as an MVP for the current CU. The table with multiple HMVP candidates is maintained during the encoding/decoding process. The table is reset (emptied) when a new row of CTUs is encountered. Whenever there is a non-subblock inter-coded CU, associated motion information is added to a last entry of the HMVP table as a new HMVP candidate.

A size of the HMVP table is set to 6. When a new HMVP candidate is inserted into the HMVP table, a constrained FIFO rule is utilized, wherein redundancy check is firstly applied to find whether there is an identical HMVP in the HMVP table. If found, the identical HMVP is removed from the HMVP table and all the HMVP candidates afterwards are moved forward, and the identical HMVP is added to the last entry of the HMVP table.

HMVP candidates may be used in the MVP candidate list construction process. The latest several HMVP candidates in the HMVP table are checked in order and inserted into the MVP candidate list after the temporal MVP candidate. Redundancy check is applied on the HMVP candidates relative to the spatial candidates and/or temporal MVP candidate.

To reduce a number of redundancy check operations, the following simplifications are introduced:
Last two entries in the HMVP table are redundancy checked relative to spatial MVP candidates derived from the spatial candidates at the positions A1 and B1, respectively; and
Once a total number of available MVP candidates reaches the maximum allowed size of the MVP candidate list minus 1, the MVP candidate list construction process from HMVP candidates is terminated.

### Derivation of Pairwise Average MVP Candidates

Pairwise average MVP candidates are generated by averaging MVPs derived using a predefined pair of first two merge candidates in the existing merge candidate list. A first merge candidate in the predefined pair may be defined as p0Cand and a second merge candidate in the predefined pair may be defined as p1Cand. Averaged motion vectors are calculated according to availability of motion vectors of p0Cand and p1Cand separately for each reference picture list. If both motion vectors are available for one reference picture list, these two motion vectors are averaged even when they point to different reference pictures, and a reference picture of the averaged motion vector is set to a reference picture of p0Cand; if only one motion vector is available for one reference picture list, the motion vector is used directly; if no motion vector is available for one reference picture list, the motion vector and the reference picture index for this reference picture list are kept invalid.

### Zero MVPs

When the MVP candidate list is not full after the pairwise average MVP candidates are added, zero MVPs are inserted at the end of the MVP candidate list until the maximum allowed size of the MVP candidate list is reached.

### MMVD

As described above, in the merge mode, motion information (i.e., an MVP candidate) is implicitly derived from an MVP candidate list constructed for a current CU and is directly used as an MV of the current CU for generation of prediction samples of the current CU, which may result in a certain error between an actual MV of the current CU and the implicitly derived MVP. In order to increase the accuracy of an MV of the current CU, MMVD is introduced in VVC where a Motion Vector Difference (MVD) of the current CU is added to the implicitly derived MVP to obtain the MV of the current CU. An MMVD flag is signalled after a regular merge flag is transmitted to specify whether an MMVD mode is used for the current CU.

In the MMVD mode, after an MVP candidate is selected from first two MVP candidates in the MVP candidate list, MMVD information is signalled, wherein the MMVD information includes an MMVD candidate flag which is used to specify which one of the first two MVP candidates is selected to be used as an MV basis, a distance index for indication of motion magnitude information of the MVD, and a direction index for indication of motion direction information of the MVD.

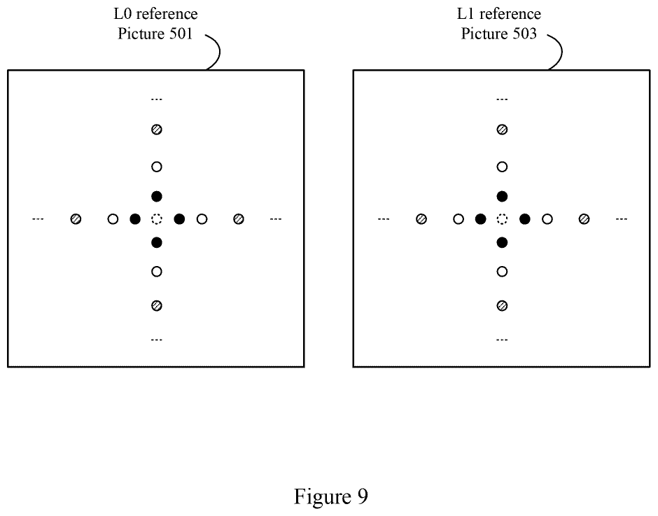

The distance index, which specifies the motion magnitude information of the MVD, indicates a pre-defined offset from a starting point (represented by, for example, a dotted circle in FIG. 9) in a reference picture (for example, L0 reference picture 501 or L1 reference picture 503 in FIG. 9) of the current CU to which the selected MVP candidate points, and the MVD may be derived from the offset and may be added to the selected MVP candidate. A relation between distance indexes and pre-defined offsets is specified in Table 1 below.

TABLE 1

| | Distance index | | | | | | | |
|---|---|---|---|---|---|---|---|---|
| | 0 | 1 | 2 | 3 | 4 | 5 | 6 | 7 |
| Offset (in unit of luma samples) | ¼ | ½ | 1 | 2 | 4 | 8 | 16 | 32 |

The direction index specifies a sign of the MVD, which represents a direction of the MVD relative to the starting point. Table 2 specifies a relation between direction indexes and pre-defined signs. It should be illustrated that the meaning of a sign of the MVD may be variant according to information of the selected MVP candidate. When the selected MVP candidate is an un-prediction MV or bi-prediction MVs with both MVs pointing to the same side of the current picture (i.e., POCs of two reference pictures (for example, reference pictures of list 0 and list 1, which are also referred to as L0 reference picture and L1 reference picture respectively) of the current picture are both greater than a POC of the current picture, or are both less than the POC of the current picture), the sign in Table 2 specifies the sign of the MVD added to the selected MVP candidate. When the selected MVP candidate is bi-prediction MVs with both MVs pointing to different sides of the current picture (i.e. a POC of one reference picture of the current picture is greater than the POC of the current picture, and a POC of the other reference picture of the current picture is less than the POC of the current picture), if a POC distance for L0 reference picture (i.e., a POC distance between the L0 reference picture and the current picture) is greater than a POC distance for L1 reference picture (i.e., a POC distance between the L1 reference picture and the current picture), the sign in Table 2 specifies a sign of an MVD for list 0 MVD0 added to an MVP for list 0 MVP0 of the selected MVP candidate and a sign of an MVD for list 1 MVD1 added to an MVP for list 1 MVP1 of the selected MVP candidate is opposite to the sign in Table 2; otherwise, if the POC distance for L1 reference picture is greater than the POC distance for L0 reference picture, the sign in Table 2 specifies the sign of MVD1 added to MVP1 and the sign of MVD0 added to MVP0 is opposite to the sign in Table 2.

TABLE 2

| Direction indexes | 00 | 01 | 10 | 11 |
|---|---|---|---|---|
| x-axis | + | − | N/A | N/A |
| y-axis | N/A | N/A | + | − |

The MVD is scaled according to the POC distances. If the POC distances for both L0 reference picture and L1 reference picture are the same, no scaling is needed for the MVD. Otherwise, if the POC distance for L0 reference picture is greater than the POC distance for L1 reference picture, MVD1 is scaled. If the POC distance for L1 reference picture is greater than the POC distance for L0 reference picture, MVD0 is scaled.

### GPM

In VVC, GPM is supported for inter prediction. The GPM is signalled using a CU-level flag as one kind of merge mode, with other merge modes including the regular merge mode, the MMVD mode, the CIIP mode and the subblock merge mode. A total of 64 partitions are supported by GPM for each possible CU size W×H (W=2^{m} and H=2ⁿ, with m, n ϵ{3, 4, 5, 6}) excluding 8×64 and 64×8.

When the GPM is used, a CU is split into two parts by a geometrically located straight line. The position of the splitting line is mathematically derived from angle and offset parameters of a specific partition. Each part of the CU obtained by the geometrical partitioning is inter-predicted using its own motion; and only uni-prediction is allowed for each partition, that is, each part has one motion vector and one reference index. The uni-prediction motion constraint is applied to ensure that like the conventional bi-prediction, only two motion compensated predictions are needed for each CU.

If the GPM is used for the current CU, then a geometric partition index indicating a partition mode of the geometric partitioning (indicating an angle and an offset of the geometric partitioning), and two merge indexes (one for each partition) are further signalled.

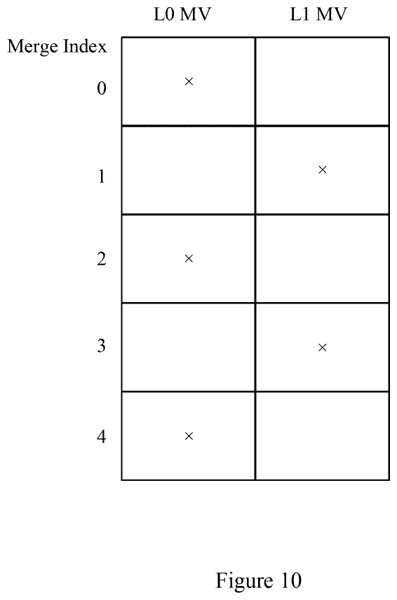

An uni-prediction candidate list is derived directly from a merge candidate list constructed according to the extended merge prediction process described above. Denote n as an index of a uni-prediction motion vector in the uni-prediction candidate list. An LX motion vector of an n^{th} merge candidate in the merge candidate list, with X equal to a parity of n, is used as the n^{th} uni-prediction motion vector for the GPM. These motion vectors are marked with “x” in FIG. 10. In a case that a corresponding LX motion vector of the n^{th} merge candidate in the merge candidate list does not exist, an L(1−X) motion vector of the same merge candidate is used instead as the uni-prediction motion vector for the GPM.

### CIIP

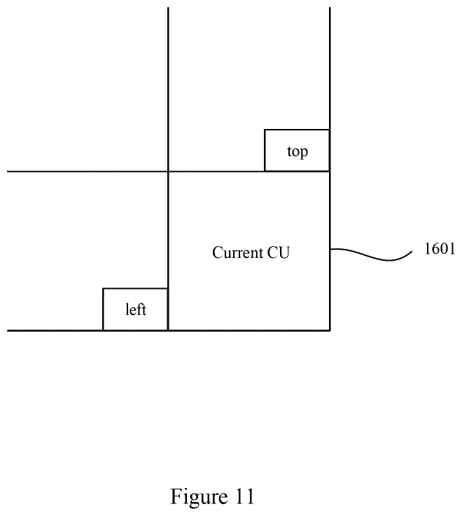

In VVC, when a CU is coded in a merge mode, if the CU contains at least 64 luma samples (that is, a width of CU times a height of the CU is equal to or larger than 64), and if both the width and the height of the CU are less than 128 luma samples, an additional flag is signalled to indicate if a CIIP mode is applied to the current CU. In the CIIP mode, a prediction signal is obtained by combining an inter prediction signal with an intra prediction signal. The inter prediction signal in the CIIP mode is derived using the same inter prediction process as that applied in the regular merge mode; and the intra prediction signal in the CIIP mode is derived following the regular intra prediction process with a planar mode. Then, the intra prediction signal and the inter prediction signal are combined using weighted averaging, where a weight value is calculated depending on coding modes of top and left neighboring blocks of the current CU 1601 (as shown in FIG. 11) as follows:
If the top neighboring block is available and is intra coded, then isIntraTop is set to 1, otherwise isIntraTop is set to 0;
If the left neighboring block is available and is intra coded, then isIntraLeft is set to 1, otherwise isIntraLeft is set to 0;
If (isIntraLeft+isIntraTop) is equal to 2, then the weight value is set to 3;
Otherwise, if (isIntraLeft+isIntraTop) is equal to 1, then the weight value is set to 2;
Otherwise, the weight value is set to 1.
The prediction signal P_{CIIP} in the CIIP mode is derived as follows:

$${P}_{CIIP} = ( ( 4 - wt ) * {P}_{inter} + wt * {P}_{intra} + 2 ) >> 2 \qquad ( 1 )$$

Where Pᵢₙₜₑᵣ is the inter prediction signal in the CIIP mode, Pᵢₙₜᵣₐ is the intra prediction signal in the CIIP mode, wt is the weight value, and >> represents a right shift operation.

### Intra Block Copy in Versatile Video Coding (VVC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:

IBC skip/merge mode: a merge candidate index is used to indicate which of the block vectors in the list from neighboring candidate IBC coded blocks is used to predict the current block. The merge list includes spatial, HMVP, and pairwise candidates.

IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### IBC Reference Region

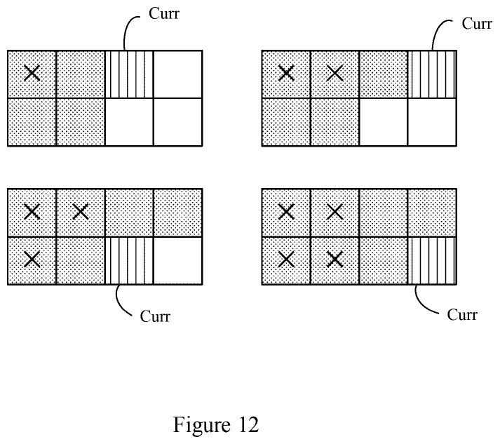

To reduce memory consumption and decoder complexity, the IBC in VVC allows only the reconstructed portion of the predefined area including the region of current CTU and some region of the left CTU. FIG. 12 illustrates the reference region of IBC Mode, where each block represents 64×64 luma sample unit.

Depending on the location of the current coding CU location within the current CTU, the following applies:

If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.

If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.

If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.

If current block falls into the bottom-right 64×64 block of the current CTU, it can only refer to the already reconstructed samples in the current CTU, using CPR mode.

This restriction allows the IBC mode to be implemented using local on-chip memory for hardware implementations.

IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:

IBC can be used with pairwise merge candidate and HMVP. A new pairwise IBC merge candidate can be generated by averaging two IBC merge candidates. For HMVP, IBC motion is inserted into history buffer for future referencing.

IBC cannot be used in combination with the following inter tools: affine motion, CIIP, MMVD, and GPM.

IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:

IBC shares the same process as in regular MV merge including with pairwise merge candidate and history-based motion predictor, but disallows TMVP and zero vector because they are invalid for IBC mode.

### Separate HMVP Buffer (5 Candidates Each) is Used for Conventional MV and IBC.

Block vector constraints are implemented in the form of bitstream conformance constraint, the encoder needs to ensure that no invalid vectors are present in the bitsream, and merge shall not be used if the merge candidate is invalid (out of range or 0). Such bitstream conformance constraint is expressed in terms of a virtual buffer as described below.

For deblocking, IBC is handled as inter mode.

If the current block is coded using IBC prediction mode, AMVR does not use quarter-pel; instead, AMVR is signaled to only indicate whether MV is inter-pel or 4 integer-pel.

The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.

At the beginning of decoding each CTU row, refresh the whole ibcBuf with an invalid value −1.

At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.

After decoding a CU contains (x, y) relative to the top-left corner of the picture, set

ibcBuf[x% wIbcBuf][y% ctbSize]=recSample[x][y]

For a block covering the coordinates (x, y), if the following is true for a block vector bv=(bv[0], bv[1]), then it is valid; otherwise, it is not valid:

$$ibcBuf [ ( x + bv [ 0 ] ) \% wIbcBuf ] [ ( y + bv ) \% ctbSize ] shall not be equal to - 1.$$

### Intra Block Copy in Enhanced Compression Model (ECM)

In ECM, IBC is improved from below aspects.

### IBC Merge/AMVP List Construction

The IBC merge/AMVP list construction is modified as follows:

Only if an IBC merge/AMVP candidate is valid, it can be inserted into the IBC merge/AMVP candidate list.

Above-right, bottom-left, and above-left spatial candidates and one pairwise average candidate can be added into the IBC merge/AMVP candidate list.

Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

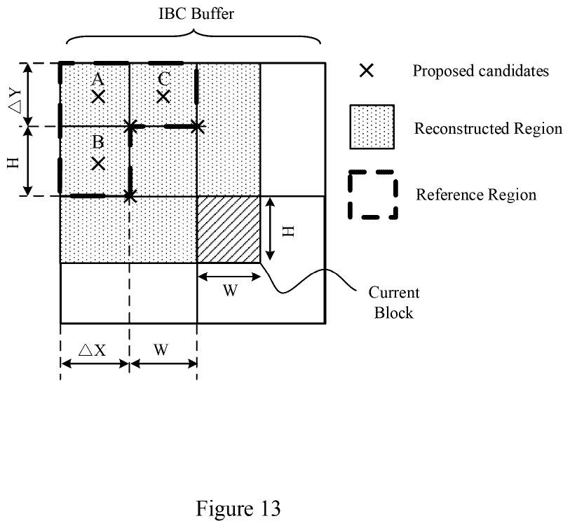

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 13.

IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 12. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### IBC Reference Area

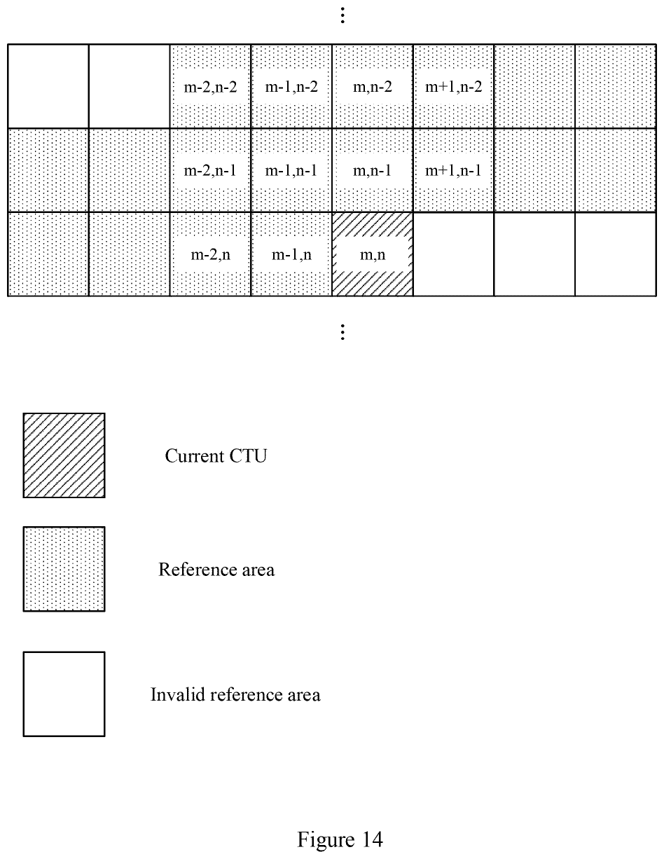

The reference area for IBC is extended to two CTU rows above. FIG. 14 illustrates the reference area for coding CTU (m,n). Specifically, for CTU (m,n) to be coded, the reference area includes CTUs with index (m−2,n−2) . . . (W,n−2), (0,n−1) . . . (W,n−1), (0,n) . . . (m,n), where W denotes the maximum horizontal index within the current tile, slice or picture. This setting ensures that for CTU size being 128, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

IBC Merge Mode with Block Vector Differences

IBC merge mode with block vector differences is adopted in ECM. The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### IBC Adaptation for Camera-Captured Content

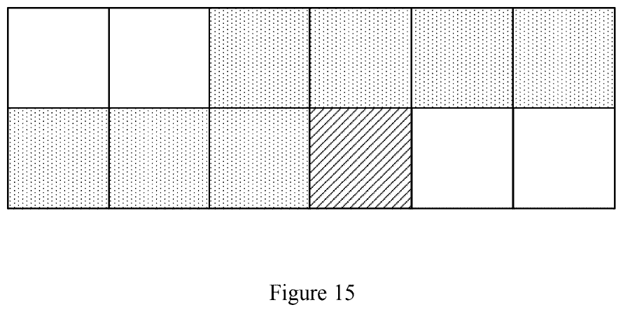

When adapt IBC for camera-captured content, IBC reference range is reduced from 2 CTU rows to 2×128 rows as shown in FIG. 15. At encoder side to reduce the complexity, the local search range is set to [−8,8] horizontally and [−8,8] vertically centered at the first block vector predictor of the current CU. This encoder modification is not applied to SCC sequences.

Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

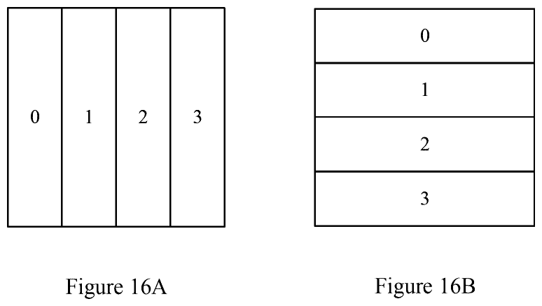

In addition, it is also proposed to modify the weights (wIntra, wInter) for the two tests if the derived intra prediction mode is an angular mode. For near-horizontal modes (2<=angular mode index <34), the current block is vertically divided as shown in FIG. 16A; for near-vertical modes (34<=angular mode index <=66), the current block is horizontally divided as shown in FIG. 16B.

The (wIntra, wInter) for different sub-blocks are shown in Table 3.

TABLE 3
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### Multi-Hypothesis Prediction (MHP)

In the multi-hypothesis inter prediction mode, one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows:

$${p}_{3} = ( 1 - α ) {P}_{bi} + α {h}_{3} \qquad ( 2 )$$

The weighting factor α is specified by the new syntax element add_hyp_weight_idx, according to the mapping presented in Table 4:

TABLE 4
The mapping between add_hyp_weight_idx and α.

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} \qquad ( 3 )$$

The resulting overall prediction signal is obtained as the last pₙ (i.e., the pₙ having the largest index n). Within this mode, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### Geometric Partitioning Mode (GPM) in ECM

GPM with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

GPM with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 5. The motion is then refined by minimizing the difference between the current template and the template in the reference picture using the same search pattern of merge mode with half-pel interpolation filter disabled.

TABLE 5

| | Partition angle | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

Table 5 shows template for the 1st and 2nd geometric partitions, where A represents using above samples, L represents using left samples, and L+A represents using both left and above samples.

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

GPM with Inter and Intra Prediction

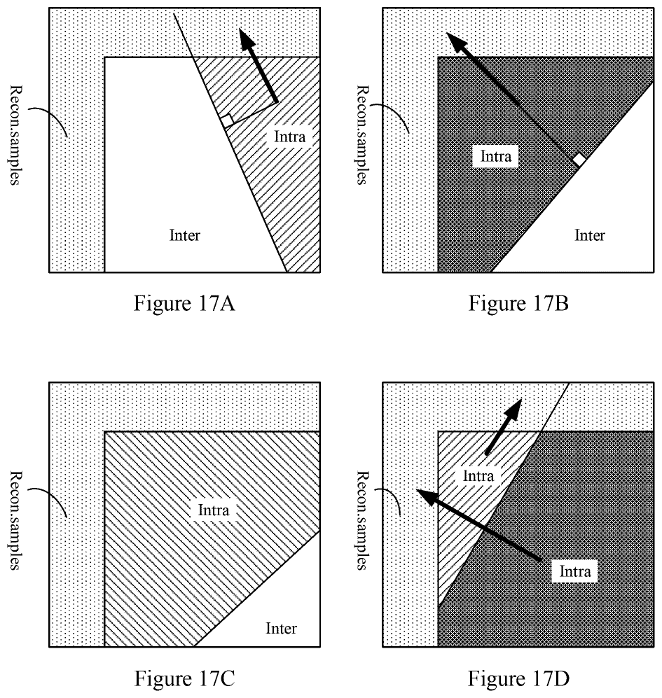

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown in FIGS. 17A to 17C, respectively. Furthermore, GPM with intra and intra prediction as shown in FIG. 17D is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 6, which are already used for GPM with template matching (GPM-TM).

TABLE 6

| | Angle of GPM | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

Table 6 shows the position of available neighboring blocks for IPM candidate derivation based on the angle of GPM block boundary. A and L denotes the above and left side of the prediction block.

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighboring blocks.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode is located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 as available split modes.

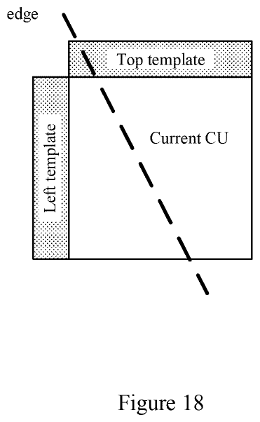

The edge on the template is extended from that of the current CU, as FIG. 18 illustrates, but GPM blending process is not used in the template area across the edge.

After ascending reordering using TM cost, an index is signaled.

### Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

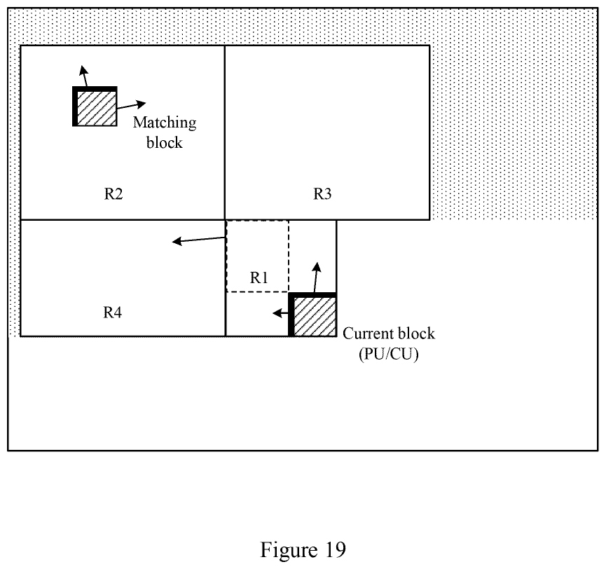

The prediction signal is generated by matching the L-shaped causal neighbor of the current block with another block in a predefined search area in FIG. 19 consisting of:
R1: current CTU
R2: top-left CTU
R3: above CTU
R4: left CTU

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

### Local Illumination Compensation (LIC)

LIC is an inter prediction technique to model local illumination variation between current block and its prediction block as a function of that between current block template and reference block template. The parameters of the function can be denoted by a scale a and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation proposed in JVET-O0066 is used for uni-prediction inter CUs with the following modifications:
intra neighbor samples can be used in LIC parameter derivation;
LIC is disabled for blocks with less than 32 luma samples;
for both non-subblock and affine modes, LIC parameter derivation is performed based on the template block samples corresponding to the current CU, instead of partial template block samples corresponding to first top-left 16×16 unit; and
samples of the reference block template are generated by using MC with the block MV without rounding it to integer-pel precision.

### OBMC

When OBMC is applied, top and left boundary pixels of a CU are refined using neighboring block's motion information with a weighted prediction as described in JVET-L0101.

Conditions of not applying OBMC are as follows:
when OBMC is disabled at SPS level;
when current block has intra mode or IBC mode;
when current block applies LIC; and
when current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
affine AMVP modes;
affine merge modes and subblock-based temporal motion vector prediction (SbTMVP); and
subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128}$$

$$PredY = \frac{( 4 - {w}_{0} ) \times FwdMap ( {Inter}_{predY}^{′} ) + {w}_{0} \times {Intra}_{predY}}{4}$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

### Template Matching Based OBMC

In template matching based OBMC scheme, instead of directly using the weighted prediction, the prediction value of CU boundary samples derivation approach is decided according to the template matching costs, including using current block's motion information only, or using neighboring block's motion information as well with one of the blending modes.

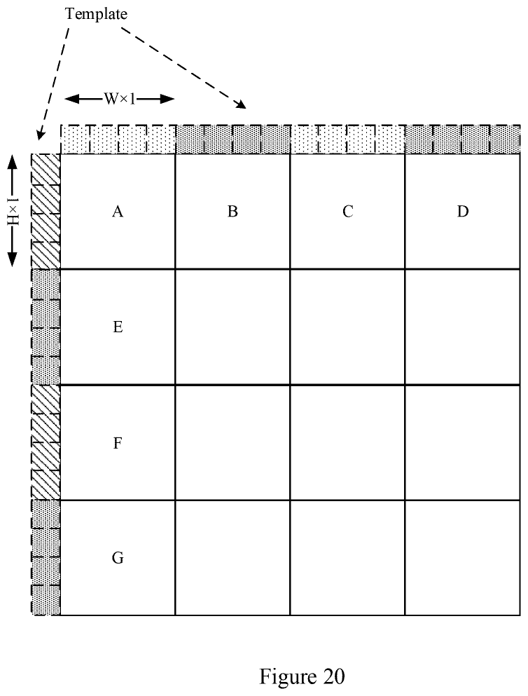

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N (FIG. 20).

For each 4×4 top block (or N 4×4 blocks group), the prediction value of boundary samples is derived following the below steps.

Take block A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:
Cost1 is calculated according to A's motion information.
Cost2 is calculated according to AboveNeighbor_A's motion information.
Cost3 is calculated according to weighted prediction of A's and AboveNeighbor_A's motion information with weighting factors as ¾ and ¼ respectively.

Second, choose one approach to calculate the final prediction results of boundary samples by comparing Cost1, Cost2 and Cost 3.

The original MC result using current block's motion information is denoted as Pixel1, and the MC result using neighboring block's motion information is denoted as Pixel2. The final prediction result is denoted as NewPixel.

If Cost1 is minimum, then NewPixel(i,j)=Pixel1(i,j).

If (Cost2+(Cost2>>2)+(Cost2>>3))<=Cost1, then blending mode 1 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) >> 5$$

$$NewPixel ( i , 1 ) = ( 7 \times Pixel 1 ( i , 1 ) + Pixel 2 ( i , 1 ) + 4 ) >> 3$$

$$NewPixel ( i , 2 ) = ( 15 \times Pixel 1 ( i , 2 ) + Pixel 2 ( i , 2 ) + 8 ) >> 4$$

$$NewPixel ( i , 3 ) = ( 31 \times Pixel 1 ( i , 3 ) + Pixel 2 ( i , 3 ) + 16 ) >> 5$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) >> 5$$

If Cost1<=Cost2, then blending mode 2 is used.

For luma blocks, the number of blending pixel rows is 2.

$$NewPixel ( i , 0 ) = ( 15 \times Pixel 1 ( i , 0 ) + Pixel 2 ( i , 0 ) + 8 ) >> 4$$

$$NewPixel ( i , 1 ) = ( 31 \times Pixel 1 ( i , 1 ) + Pixel 2 ( i , 1 ) + 16 ) >> 5$$

For chroma blocks, the number of blending pixel rows/columns is 1.

$$NewPixel ( i , 0 ) = ( 15 \times Pixel 1 ( i , 0 ) + Pixel 2 ( i , 0 ) + 8 ) >> 4$$

Otherwise, blending mode 3 is used.

For luma blocks, the number of blending pixel rows is 4.

$$NewPixel ( i , 1 ) = ( 7 \times Pixel 1 ( i , 1 ) + Pixel 2 ( i , 1 ) + 4 ) >> 3$$

$$NewPixel ( i , 2 ) = ( 15 \times Pixel 1 ( i , 2 ) + Pixel 2 ( i , 2 ) + 8 ) >> 4$$

$$NewPixel ( i , 3 ) = ( 31 \times Pixel 1 ( i , 3 ) + Pixel 2 ( i , 3 ) + 16 ) >> 5$$

For chroma blocks, the number of blending pixel rows is 1.

$$NewPixel ( i , 0 ) = ( 7 \times Pixel 1 ( i , 0 ) + Pixel 2 ( i , 0 ) + 4 ) >> 3$$

According to one aspect of the present disclosure, methods and devices for FIBC are provided.

Although the existing IBC scheme can provide significant improvement of intra coding in the ECM, there is room to further improve its performance. Meanwhile, some parts of the existing convolutional cross-component model (CCCM) mode also need to be simplified for efficient codec hardware implementations or improved for better coding efficiency. Furthermore, the trade-off between its implementation complexity and its coding efficiency benefit needs to be further improved.

In this disclosure, to address the issues as pointed out above, methods are provided to further improve the existing design of the IBC. In general, the main features of the proposed technologies in this disclosure are summarized as follows.

The IBC prediction is filtered with CCCM tool. Filtered intra block copy (FIBC) is a special intra prediction mode that applies a filter on the IBC-based prediction block to increase prediction accuracy and adapt the characteristics of the copied block to the local neighbourhood.

In FIBC, training samples may be adjacent to the current block. It is known that reference from local regions can improve the accuracy of prediction in prediction.

In FIBC, training samples may be not adjacent to the current block. It is known that reference from non-local regions can also improve the accuracy of prediction in prediction.

In FIBC, only one hypothesis may be utilized, i.e., the best matching block which leads to the minimum matching cost is selected as the final prediction.

In FIBC, multiple hypothesis may also be utilized.

It should be understood that the figures in this disclosure may be combined with all examples mentioned in this disclosure and the disclosed methods may be applied independently or jointly.

### Filtered Intra Block Copy (FIBC)

According to one or more embodiments of the disclosure, IBC prediction is filtered with CCCM tool. Different methods may be used to achieve this goal. The existing CCCM mode applies a variety of filters for predicting the chroma sample value based on corresponding luma sample values. Unlike CCCM, Filtered intra block copy (FIBC) is a special intra prediction mode that applies a filter on the IBC-based prediction block to predict the target luma or chroma sample of the current block based on the corresponding luma or chroma samples of the reference block respectively, in order to increase prediction accuracy and adapt the characteristics of the copied block to the local neighbourhood.

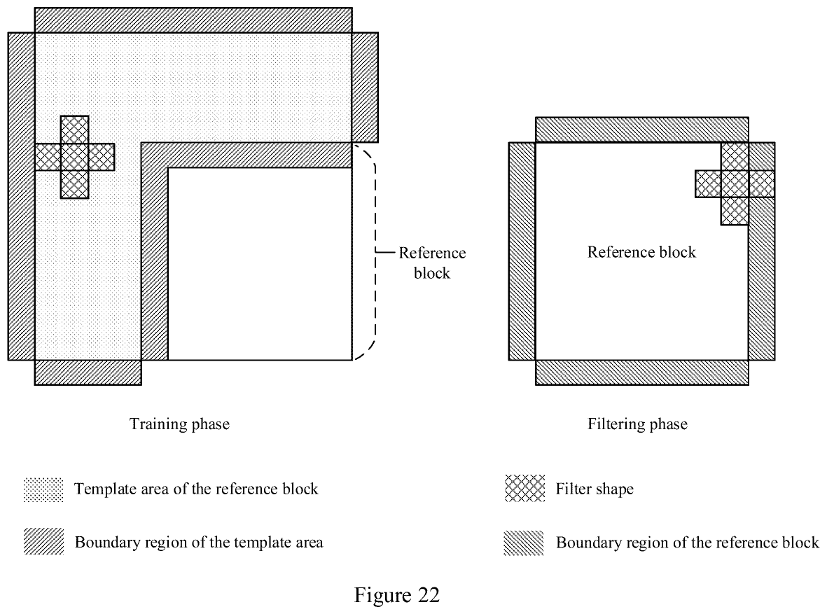

According to one or more embodiments of the disclosure, reconstructed luma/chroma samples over the template area of the reference block are used as inputs to the filter during training phase and corresponding reconstructed luma/chroma sample in the template area of the current block is the target. In one example, FIG. 22 illustrates one filter shape (cross-shaped) and the training area for the reference block. It should be understood that for this filter shape, both the template area and the boundary region of the template area can be part of the training area for the reference block. Reconstructed samples in the boundary region may be used in training when available and they are padded with closest available sample when unavailable. On the other hand, a training area for the current block can be determined as the template area of the current block. In the filtering phase where the filter coefficients of the filter have been trained/determined through the training phase, the filter may be applied to the corresponding sample values of reference block and the boundary region of the reference block to predict each of the sample values for the current block.

According to one or more embodiments of the disclosure, the filter coefficients (i.e., parameters) are derived using the regression based MSE minimization technique (i.e., LDL decomposition) existing in ECM and being utilized by other tools such as CCCM.

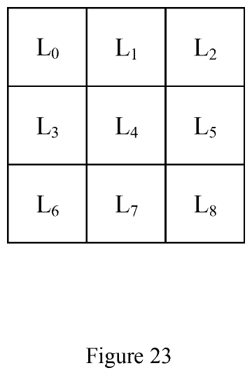

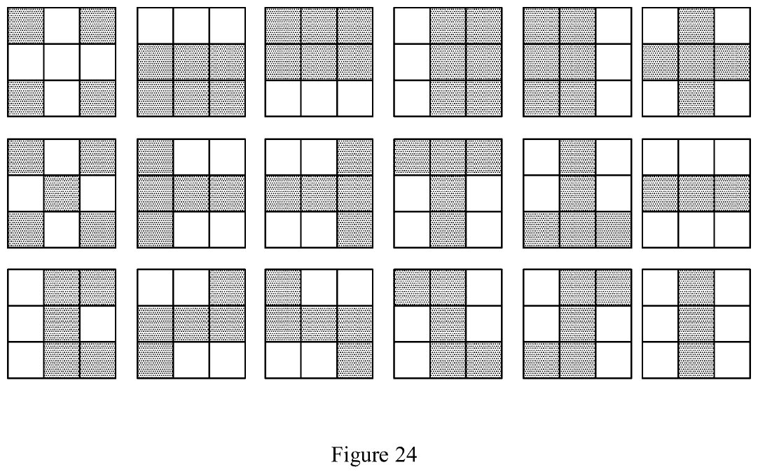

According to one or more embodiments of the disclosure, the convolutional N-tap (N is an integer and larger than 1) filter may include (N−1−M)-tap (M is an integer) spatial terms, M nonlinear terms and a bias term. The (N−1−M)-tap spatial terms correspond to neighboring sample values, such as luma samples (i.e., L₀, L₁, . . . , L₈), from the reconstructed reference block as illustrated in FIG. 23. In this example, the formula for each new prediction luma sample is as follows:

$$predVal = {\sum }_{i = 0}^{N - 2 - M} {α}_{i} \cdot ( {L}_{i} - offsetLuma ) + {\sum }_{i = 0}^{M - 1} {α}_{i + N - M - 1} \cdot ( ( {( {L}_{i} - offsetLuma )}^{2} + β ) >> bitDepth ) + {α}_{N - 1} \cdot β + offsetLuma$$

Where αᵢ is the coefficient associated with L₁ and β is the offset (i.e., 1<<(bitDepth−1)). Reference luma sample value for the top-left sample adjacent to the current block can be used as the offsetLuma value. The position and number of spatial term and nonlinear term may be different. Examples of different shape/number of filter taps as illustrated in FIG. 24. For another examples, using different position and number as shown in following table.

| Number | |
|---|---|
| of terms | Position of terms |
| 1 | Any one of {L₀, L₁, L₂, L₃, L₄, L₅, L₆, L₇, L₈}, i.e., |
| | (L₀) or (L₁) or (L₂) or (L₃) or (L₄) or (L₅) or (L₆) |
| | or (L₇) or (L₈) |
| 2 | Any two of {L₀, L₁, L₂, L₃, L₄, L₅, L₆, L₇, L₈}, i.e., |
| | (L₀, L₁) or (L₀, L₂) or (L₀, L₃) or (L₀, L₄) or (L₀, L₅) |
| | or (L₁, L₂) or (L₁, L₃) or (L₁, L₄) or (L₁, L₅) or (L₂, L₃) |
| | or (L₂, L₄) or (L₂, L₅) or (L₃, L₄) or (L₃, L₅) or (L₄, L₅) |
| 3 | Any three of {L₀, L₁, L₂, L₃, L₄, L₅, L₆, L₇, L₈}, i.e., |
| | (L₀, L₁, L₂) or (L₀, L₁, L₃) or (L₀, L₁, L₄) or (L₀, L₁, L₅) |
| | or (L₀, L₂, L₃) or (L₀, L₂, L₄) or (L₀, L₂, L₅) or (L₀, L₃, |
| | L₄) or (L₀, L₃, L₅) or (L₀, L₄, L₅) or (L₁, L₂, L₃) or (L₁, |
| | L₂, L₄) or (L₁, L₂, L₅) or (L₁, L₃, L₄) or (L₁, L₃, L₅) or |
| | (L₁, L₄, L₅) or (L₂, L₃, L₄) or (L₂, L₃, L₅) or (L₂, L₄, L₅) |
| | or (L₃, L₄, L₅) |
| 4 | Any four of {L₀, L₁, L₂, L₃, L₄, L₅, L₆, L₇, L₈}, i.e., |
| | (L₂, L₃, L₄, L₅) or (L₁, L₃, L₄, L₅) or (L₁, L₂, L₄, L₅) or |
| | (L₁, L₂, L₃, L₅) or (L₁, L₂, L₃, L₄) or (L₀, L₃, L₄, L₅) or |
| | (L₀, L₂, L₄, L₅) or (L₀, L₂, L₃, L₅) or (L₀, L₂, L₃, L₄) or |
| | (L₀, L₁, L₄, L₅) or (L₀, L₁, L₃, L₅) or (L₀, L₁, L₃, L₄) or |
| | (L₀, L₁, L₂, L₅) or (L₀, L₁, L₂, L₄) or (L₀, L₁, L₂, L₃) |
| 5 | Any five of {L₀, L₁, L₂, L₃, L₄, L₅, L₆, L₇, L₈}, i.e., |
| | (L₀, L₁, L₂, L₃, L₄) or (L₀, L₁, L₂, L₃, L₅) or (L₀, L₁, |
| | L₂, L₄, L₅) or (L₀, L₁, L₃, L₄, L₅) or (L₀, L₂, L₃, L₄, |
| | L₅) or (L₁, L₂, L₃, L₄, L₅) |
| 6 | Any six of {L₀, L₁, L₂, L₃, L₄, L₅, L₆, L₇, L₈}, i.e., |
| | (L₀, L₁, L₂, L₃, L₄, L₅) |
| 7 | Any seven of {L₀, L₁, L₂, L₃, L₄, L₅, L₆, L₇, L₈}, i.e., |
| | (L₀, L₁, L₂, L₃, L₄, L₅, L₆) |
| 8 | Any eight of {L₀, L₁, L₂, L₃, L₄, L₅, L₆, L₇, L₈}, i.e., |
| | (L₀, L₁, L₂, L₃, L₄, L₅, L₆, L₇) |
| 9 | (L₀, L₁, L₂, L₃, L₄, L₅, L₆, L₇, L₈) |

According to one or more embodiments of the disclosure, template size and shapes may be same as in intra TMP, the template size used for training is 4 lines above and to the left of the current block depending on their availability.

According to one or more embodiments of the disclosure, template size and shapes may be same as in CCCM, the template size used for training is 6 lines above and to the left of the current block depending on their availability.

According to one or more embodiments of the disclosure, the template size used for training may be N lines above and to the left of the current block depending on their availability, N is an integer.

According to one or more embodiments of the disclosure, the template size used for training may be N lines above of the current block depending on their availability, N is an integer.

According to one or more embodiments of the disclosure, the template size used for training may be N lines left of the current block depending on their availability, N is an integer.

According to one or more embodiments of the disclosure, the reference samples/template area of the reference block/template area of the current block may be predefined or signaled/switched in different coding levels, such as SPS/DPS/VPS/SEI/APS/PPS/PH/SH/Region/CTU/CU/Subblock/Sample levels.

According to one or more embodiments of the disclosure, location information may be used to calculate model parameters, including utilizing horizontal/vertical/diagonal distance and their non-linear term, one or more location information may be used for the purpose. In one example, the location based parameter is related to the vertical and horizontal coordinates (Xc, Yc) of the center luma sample and it is calculated with respect to the top-left coordinates (Xtl, Ytl) of the block, e.g. Xc−Xtl+Yc−Ytl. In another example, the location based parameters are related to the vertical and horizontal coordinates (Xc, Yc) of the center luma sample and they are calculated with respect to the top-left coordinates (Xtl, Ytl) of the block, e.g. Xc−Xtl+Yc−Ytl, Xc−Xtl, Yc−Ytl. In yet another example, the location based parameter is related to the vertical and horizontal coordinates (Xc, Yc) of the center luma sample and it is calculated with respect to the top-left coordinates (Xtl, Ytl) of the block, e.g. (Xc−Xtl+Yc−Ytl)/N, where N is predefined number, such as 2. In yet another example, the location based parameters are related to the vertical and horizontal coordinates (Xc, Yc) of the center luma sample and they are calculated with respect to the top-left coordinates (Xtl, Ytl) of the block, e.g. (Xc−Xtl+Yc−Ytl)/N1, (Xc−Xtl)/N2, (Yc−Ytl)/N3, where N1-N3 are predefined numbers, such as 2, 3 and 4. In yet another example, the location based nonlinear terms are represented as power of two of the horizontal/vertical/diagonal distance, e.g. (Xc−Xtl+Yc−Ytl)*(Xc−Xtl+Yc−Ytl), (Xc−Xtl)*(Xc−Xtl), (Yc−Ytl)*(Yc−Ytl), where (Xc, Yc) are vertical and horizontal coordinates of the center luma sample and (Xtl, Ytl) are top-left coordinates.

According to one or more embodiments of the disclosure, one enablement flag can be signaled in the bitstream to indicate the FIBC mode used. The enablement flag can be signaled in different coding levels, such as SPS/DPS/VPS/SEI/APS/PPS/PH/SH/Region/CTU/CU/Subblock/Sample levels.

According to one or more embodiments of the disclosure, instead of explicitly signaling the selected mode flag, the mode flag can be derived at decoder to save bit overhead.

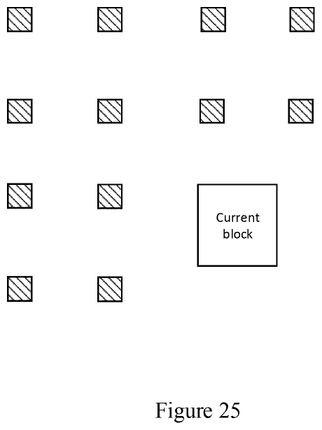

According to one or more embodiments of the disclosure, samples in regions non-adjacent to the current block can be used to derive a model for the current block. In one embodiment, one candidate region list with N candidates may be constructed by checking potential M×M regions in order. If a checked region is available, it is put into the candidate region list. For example, a candidate region list with 6 candidates is constructed by checking potential 8×8 regions in order. The top-left positions of the potential 8×8 regions are predetermined as {(−xStep, 0), (0, −yStep), (xStep, −yStep), (−xStep, yStep), (−xStep, −yStep), (−2*xStep, 0), (0, −2*yStep), (−2*xStep, 2*yStep), (2*xStep, −2*yStep), (−2*xStep, yStep), (xStep, −2*yStep), (−2*xStep, −yStep), (−xStep, −2*yStep), (−2*xStep, −2*yStep), (−xStep/2, 0), (0, −yStep/2), (xStep/2, −yStep/2), (−xStep/2, yStep/2), (−xStep/2, −yStep/2)}, where xStep=Max(width, 16), yStep=Max(height, 16). FIG. 25 show some possible positions of candidate regions.

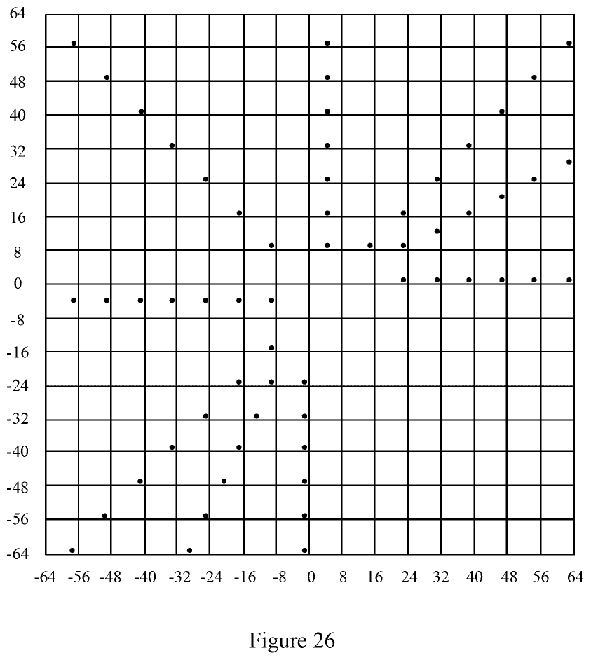

According to one or more embodiments of the disclosure, one non-adjacent neighboring candidates with N candidates may be constructed by positions and inclusion order of the spatial non-adjacent neighboring candidates from two sets of spatial non-adjacent neighboring candidates in inter merge mode. If a checked region is available, it is put into the candidate region list. FIG. 26 shows some possible positions of candidates.

According to one or more embodiments of the disclosure, inherited parameters of FIBC from previously decoded TB/CB/slice/picture/sequence level may be used in the current block. According to one or more embodiments of the disclosure, one control flag is signaled in TB/CB/slice/picture/sequence level to indicate whether the signaling of inherited FIBC is enabled or disabled. When the control flag is signaled as enabled, a flag of inherited FIBC is further signaled to decoder to indicate whether the inherited FIBC is used or not at signaled level.

According to one or more embodiments of the disclosure, the derived parameters of FIBC from previous decoded TB/CB/slice/picture/sequence level can be stored and used as current FIBC (which is called inherited FIBC). In one embodiment, a history-based FIBC (H-FIBC) table may be maintained similar to the HMVP table. In one embodiment, one index value can be signaled in the bitstream to indicate which candidate model in the H-FIBC table is selected. In one embodiment, after decoding a FIBC coded block, the corresponding table may be updated. In one embodiment, the size of H-FIBC table is N. N is an integer (e.g. 4, 5, 6, 7).

### Multi-Hypothesis FIBC

According to one or more embodiments of the disclosure, more than one prediction block candidates are used and weighted to generate the final prediction of the current block. Assume that N prediction block candidates are used.

### Prediction Block Candidate Derivation

In one embodiment, the prediction block candidates are searched and selected according to the criterion of minimizing template matching cost, i.e., the top N candidates which lead to the minimum template matching cost are selected. The template matching cost can be not limited to SAD (sum of absolute difference) and SSE (sum of square error).

In one embodiment, the prediction block candidates may be selected according to the predefine mode, i.e., planar mode.

In one embodiment, the prediction block candidates may be selected according to the neighbor predefine mode, i.e., top predefine mode, left predefine mode.

### Fixed Multi-Hypothesis FIBC

In this embodiment, the weighting factors to generate the final prediction block are predefined and fixed at both the encoder and decoder side. As an example, equal weighting factors can be used, i.e., 1/N for all the candidate blocks.

### Adaptive Multi-Hypothesis Intra FIBC

To adapt to the diverse characteristics of video content, adaptive multi-hypothesis intra FIBC methods are also proposed.

In one embodiment, the weighting factors can be derived based on the template matching costs. Denote the template matching costs of the N candidates as C₁, C₂, . . . , C_{N}, the weighting factors are calculated as follow.

$${ω}_{i} = \frac{1}{N - 1} - \frac{{C}_{i}}{( N - 1 ) {\sum }_{k = 1}^{N} {C}_{k}} , i = 1 , 2 , … , N \qquad ( 4 )$$

It should be noted that the template matching cost can be measured with (but not limited to) SAD and SSE.

In yet another embodiment, the weighting factors can be derived/switched based on the block size or syntax element signaled in different coding levels, such as SPS/DPS/VPS/SEI/APS/PPS/PH/SH/Region/CTU/CU/Subblock/Sample levels.

In yet another embodiment, the weighting factors can be derived at the encoder side and then signaled in the bitstream to the decoder. Denote the N prediction block candidates as P₁, P₂, . . . , P_{N} and the current block as X, then the weighting factors can be solved by the following equation:

$${\sum }_{i = 1}^{N} {ω}_{i} {P}_{i} = X \qquad ( 5 )$$

Equation (5) can be solved using Wiener-Hopf equations as ALF. The derived filter coefficients are then quantized to integer type and signaled in the block level.

In yet another embodiment, the weighting factors are derived based on the templates and the derived weighting factors are applied to the prediction block candidates to generate the final prediction block. Denote the templates of the prediction candidates as T₁, T₂, . . . , T_{N} and the current block as T, then the weighting factors can be derived using the following equation:

$${\sum }_{i = 1}^{N} {ω}_{i} {T}_{i} = T \qquad ( 6 )$$

Equation (6) can be solved using Wiener-Hopf equations. Then the final prediction block can be calculated as

$${\sum }_{i = 1}^{N} {ω}_{i} {P}_{i} ,$$

where Pᵢ represents the i-th prediction block candidate.

FIBC mode exploits the nonlocal correlation to improve the prediction accuracy, in which similar blocks are searched and used to generate the final prediction block. In this embodiment, it is proposed to combine the nonlocal mean filtering and multi-hypothesis FIBC, which is described as follow. In the first step, N prediction block candidates are searched and identified as conducted in the FIBC. In the second step, the weighting factor is calculated as follows.

$${ω}_{i} = \frac{1}{Z [ i ]} {e}^{- \frac{{D}_{i}}{{h}^{2}}} \qquad ( 7 )$$

Where Dᵢ is used to measure the distance between the template of the i-th prediction block candidate and the template of the current block, h is used as the degree of weighting and Z[i] is the normalization constant:

$$Z [ i ] = {\sum }_{i = 1}^{N} {e}^{- \frac{{D}_{i}}{{h}^{2}}} \qquad ( 8 )$$

To calculate the weighting factor in equation (7), the strength of weighting should be determined first. In this disclosure, several methods are proposed to decide the weighting strength.

In the first method, a weighting strength candidate list including some typical weighting strength values is defined and fixed at both encoder and decoder side. At the encoder side, the weighting strength values are checked using rate distortion optimization and the optimal weighting strength value is identified and signaled in the bitstream to the decoder side.

In the second method, the weighting strength value is estimated using the template of the prediction block candidates and the template of the current block. Denote the templates of the prediction candidates as T₁, T₂, . . . , T_{N} and the current block as T. Then the weighting strength value can be solved using the following equation:

$${\sum }_{i = 1}^{N} {ω}_{i} {T}_{i} = {\sum }_{i = 1}^{N} \frac{1}{Z [ i ]} {e}^{- \frac{{D}_{i}}{{h}^{2}}} {T}_{i} = T \qquad ( 9 )$$

In the third method, the weighting strength value can be estimated using the QP value and variance of the template of the current block, i.e., the relationship between the weighting strength value, QP value and the template variance can be fitted offline.

To better exploit the nonlocal correlation in the FIBC, in this embodiment singular value decomposition (SVD) is utilized to generate the final prediction block from the prediction block candidates. The width and height of the current block are denoted as W and H, the area of the current block is denoted as d=H×W.

Step1. K prediction block candidates yᵢ are searched and identified as conducted in the FIBC.

Step2. The K prediction block candidates of the current block y construct the block group G and are arranged as a matrix:

$${Y}_{G} = [ {y}_{G}^{( 1 )} , {y}_{G}^{( 2 )} , … , {y}_{G}^{( K )} ] \qquad ( 10 )$$

Where Y_{G} is a matrix with size of d×K by arranging every candidate in group G as a column vector.

Step3. Perform SVD decomposition on the matrix Y_{G}.

$$SVD ( {Y}_{G} ) = {U}_{G} {Λ}_{G} {V}_{G}^{*} \qquad ( 11 )$$

Step4. Apply soft-thresholding operation on the singular value matrix Λ_{G}.

$${Λ}_{{G}_{i} , τ} = softTh ( {Λ}_{G} , τ ) \qquad ( 12 )$$

Where softTh( ) is a function which shrinks the diagonal elements of Λ_{G} with the threshold τ. For the k-th diagonal element in Λ_{G}, it is shrunken by the nonlinear function D_{τ(k)} at level τ(k):

$${D}_{τ ( k )} : {λ}_{k , τ ( k )} = max ( \vert {λ}_{k} \vert - τ ( k ) , 0 ) \qquad ( 13 )$$

Λ_{G,τ} is the matrix composed of the shrunken singular values, λ_{k,τ(k)} at diagonal positions.

Step5. Perform inverse SVD to obtain the filtered patch group.

$${\hat{X}}_{G} = {U}_{G} {Λ}_{G , τ} {V}_{G}^{*} \qquad ( 14 )$$

One of the key steps is to determine the thresholding values for each diagonal elements in step 4. In this invention, the thresholding values are calculated as follows. The threshold is estimated for each group of image patches with the following equation:

$${τ}_{G} ( k ) = c \times \frac{{σ}_{n , G}^{2}}{{σ}_{x , G , k}} \qquad ( 15 )$$

Where σ_{n,G} is the standard deviation of noise, and σ_{x,G,k} is the standard deviation of the original block in the k-th dimension of SVD space for group G. The deviation of the original block in SVD space is estimated as follow.

$${σ}_{x , G , k} = \sqrt{max ( \frac{{λ}_{G , k}^{2}}{min ( d , K )} - ω \times {σ}_{n , G}^{2} , 0 )} \qquad ( 16 )$$

Where λ_{G,k}² is the k-th singular value of Y_{G}_{ᵢ}. When σ_{x,G,k} is zero, the soft-thresholding operation is skipped. In addition, the deviation of noise is estimated with the deviation of the predicted block using a power function which is parameterized with α and β.

$${σ}_{n} = α \times {σ}_{y}^{β} \qquad ( 17 )$$

Where σ_{y} is calculated as follows,

$${σ}_{y} = \frac{1}{K} {\sum }_{k = 0}^{K} \sqrt[2]{{\sum }_{i = 1}^{{p}^{2}} \frac{{( {y}_{k} ( i ) - {μ}_{k} )}^{2}}{{p}^{2}}} , {μ}_{k} = \frac{1}{{p}^{2}} {\sum }_{i = 1}^{{p}^{2}} {y}_{k} ( i ) \qquad ( 18 )$$

Here yₖ(i) represents the i-th pixel of prediction block candidate vector yₖ.

### Multi-Hypothesis FIBC Signaling

In this disclosure, the proposed multi-hypothesis FIBC can be utilized as a replacement of the current FIBC mode or the encoder can adaptively select FIBC mode or multi-hypothesis FIBC mode.

In one embodiment, the proposed multi-hypothesis FIBC is used as a replacement of the current FIBC mode, i.e., always using multiple hypothesis for prediction.

In yet another embodiment, one of the multi-hypothesis FIBC methods in the above sections is used jointly with the current FIBC mode. A flag is signaled in the bitstream to indicate whether multi-hypothesis FIBC mode is applied to the CU.

In yet another embodiment, more than one multi-hypothesis FIBC methods in the above sections is used jointly with the current FIBC mode. A flag is firstly signaled in the bitstream to indicate whether multi-hypothesis FIBC mode is applied. Then an index is signaled to indicate which of the multi-hypothesis FIBC methods is applied to the CU.

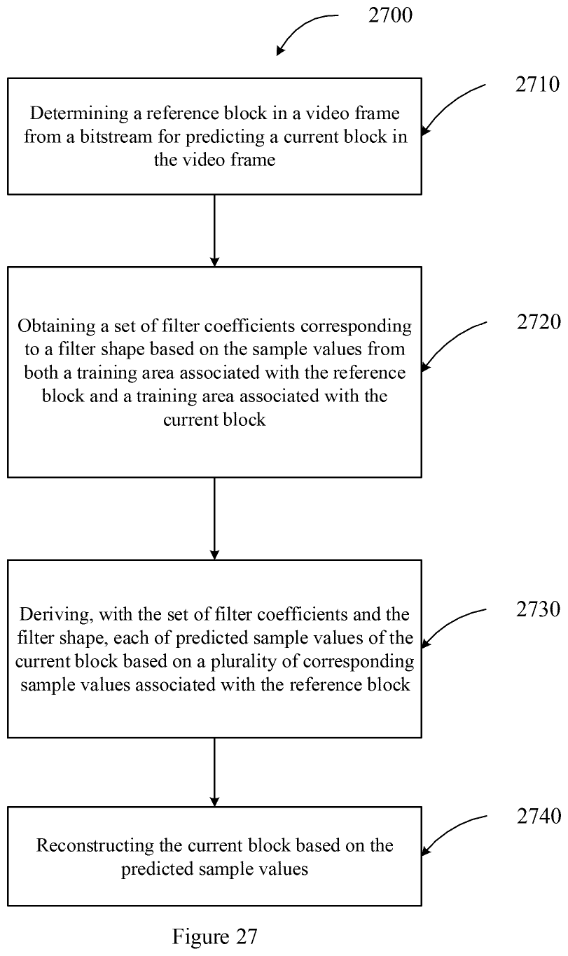

FIG. 27 illustrates a workflow of a method 2700 for decoding video data according to one or more aspects of the present disclosure.

At step 2710, the method 2700 comprises determining a reference block in a video frame from a bitstream for predicting a current block in the video frame.

At step 2720, the method 2700 comprises obtaining a set of filter coefficients corresponding to a filter shape based on the sample values from both a training area associated with the reference block and a training area associated with the current block.

At step 2730, the method 2700 comprises deriving, with the set of filter coefficients and the filter shape, each of predicted sample values of the current block based on a plurality of corresponding sample values associated with the reference block.

At step 2740, the method 2700 comprises reconstructing the current block based on the predicted sample values.

In one example, deriving each of predicted sample values of the current block comprises: deriving each of predicted luma sample values of the current block based on a plurality of corresponding luma sample values associated with the reference block; or deriving each of predicted chroma sample values of the current block based on a plurality of corresponding chroma sample values associated with the reference block.

In one example, deriving each of predicted sample values of the current block comprises: performing convolution operation on the set of the filter coefficients and the plurality of corresponding sample values to derive a result of the convolution operation, and deriving each of the predicted sample values based on the result of the convolution operation and a reference sample value associated with the current block.

In one example, the plurality of corresponding sample values comprise one or more sample values represented as one or more of a plurality of sample values associated with the reference block reduced by the reference sample value respectively.

In one example, the plurality of corresponding sample values comprise one or more sample values represented as the square of one or more of a plurality of sample values associated with the reference block reduced by the reference sample value respectively.

In one example, the reference sample value is the sample value of the top-left sample adjacent to the current block.

In one example, the training area associated with the reference block comprise N lines above and/or left to the reference block, and the training area associated with the current block comprise N lines above and/or left to the current block, wherein N is an integer.

In one example, the training area associated with the reference block is non-adjacent to the reference block, and the training area associated with the current block is non-adjacent to the current block.

In one example, the method 2700 further comprises deriving each of predicted sample values of the current block based on a plurality of corresponding sample values associated with at least one second reference block in the video frame; and reconstructing the current block by applying weighting factors for the predicted sample values.

In one example, the method 2700 further comprises obtaining information for one or more coding levels indicating at least one of: the filter shape; the template area of the reference block; the template area of the current block; whether to use inherited filter coefficients from a previously decoded block; the filter coefficients inherited from the previously decoded block; or the weighting factors.

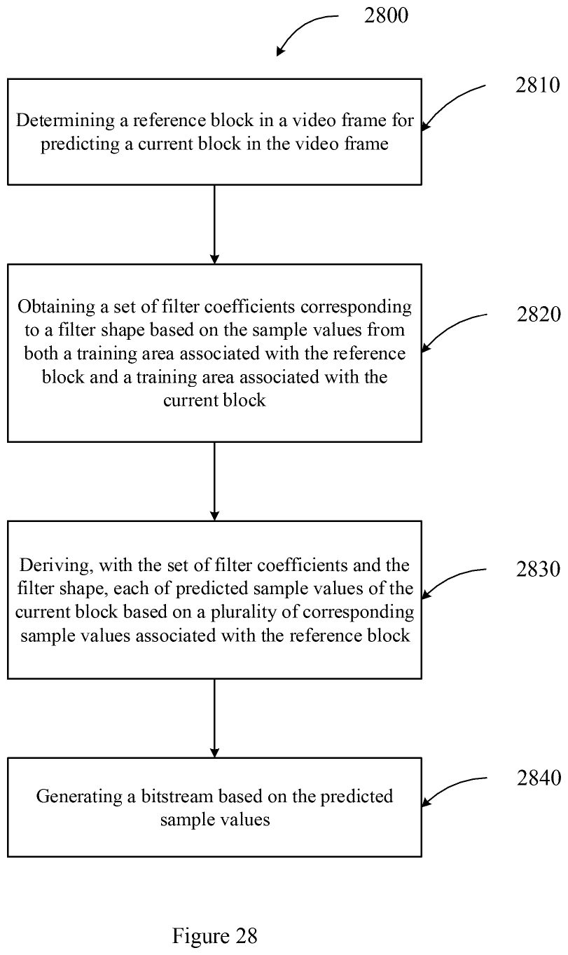

FIG. 28 illustrates a workflow of a method 2800 for encoding video data according to one or more aspects of the present disclosure.

At step 2810, the method 2800 comprises determining a reference block in a video frame for predicting a current block in the video frame.

At step 2820, the method 2800 comprises obtaining a set of filter coefficients corresponding to a filter shape based on the sample values from both a training area associated with the reference block and a training area associated with the current block.

At step 2830, the method 2800 comprises deriving, with the set of filter coefficients and the filter shape, each of predicted sample values of the current block based on a plurality of corresponding sample values associated with the reference block.

At step 2840, the method 2800 comprises generating a bitstream based on the predicted sample values.

In one example, deriving each of predicted sample values of the current block comprises: deriving each of predicted luma sample values of the current block based on a plurality of corresponding luma sample values associated with the reference block; or deriving each of predicted chroma sample values of the current block based on a plurality of corresponding chroma sample values associated with the reference block.

In one example, deriving each of predicted sample values of the current block comprises: performing convolution operation on the set of the filter coefficients and the plurality of corresponding sample values to derive a result of the convolution operation, and deriving each of the predicted sample values based on the result of the convolution operation and a reference sample value associated with the current block.

In one example, the plurality of corresponding sample values comprise one or more sample values represented as one or more of a plurality of sample values associated with the reference block reduced by the reference sample value respectively.

In one example, the plurality of corresponding sample values comprise one or more sample values represented as the square of one or more of a plurality of sample values associated with the reference block reduced by the reference sample value respectively.

In one example, the reference sample value is the sample value of the top-left sample adjacent to the current block.

In one example, the training area associated with the reference block comprise N lines above and/or left to the reference block, and the training area associated with the current block comprise N lines above and/or left to the current block, wherein N is an integer.

In one example, the training area associated with the reference block is non-adjacent to the reference block, and the training area associated with the current block is non-adjacent to the current block.

In one example, the method 2800 further comprises deriving each of predicted sample values of the current block based on a plurality of corresponding sample values associated with at least one second reference block in the video frame; and generating a bitstream based on the predicted sample values by applying weighting factors for the predicted sample values.

In one example, the method 2800 further comprises determining information for one or more coding levels indicating at least one of: the filter shape; the template area of the reference block; the template area of the current block; whether to use inherited filter coefficients from a previously decoded block; the filter coefficients inherited from the previously decoded block; or the weighting factors.

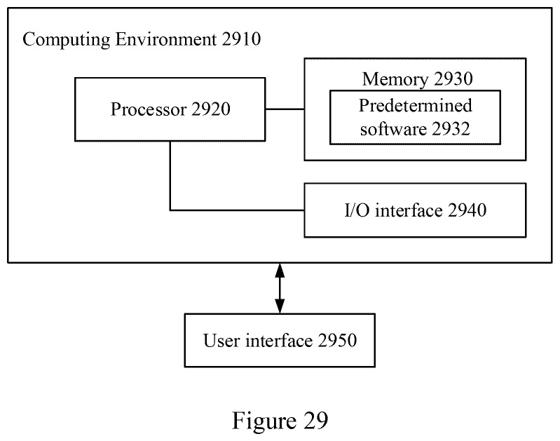

FIG. 29 shows a computing environment 2910 coupled with a user interface 2950. The computing environment 2910 can be part of a data processing server. The computing environment 2910 includes a processor 2920, a memory 2930, and an Input/Output (I/O) interface 2940.

The processor 2920 typically controls overall operations of the computing environment 2910, such as the operations associated with display, data acquisition, data communications, and image processing. The processor 2920 may include one or more processors to execute instructions to perform all or some of the steps in the above-described methods. Moreover, the processor 2920 may include one or more modules that facilitate the interaction between the processor 2920 and other components. The processor may be a Central Processing Unit (CPU), a microprocessor, a single chip machine, a Graphical Processing Unit (GPU), or the like.

The memory 2930 is configured to store various types of data to support the operation of the computing environment 2910. The memory 2930 may include predetermined software 2932. Examples of such data includes instructions for any applications or methods operated on the computing environment 2910, video datasets, image data, etc. The memory 2930 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 2940 provides an interface between the processor 2920 and peripheral interface modules, such as a keyboard, a click wheel, buttons, and the like. The buttons may include but are not limited to, a home button, a start scan button, and a stop scan button. The I/O interface 2940 can be coupled with an encoder and decoder.

According to another aspect of the present disclosure, methods and devices for IBC and Intra TMP are provided.

Currently, the IBC tool is not combined with the GPM tool. Thus, the present disclosure provides examples to combine them together, which may improve the prediction accuracy and improve the coding performance.

Currently, the coding block coded with IBC mode is not combined with the coding block coded with intra mode or inter mode. Thus, the present disclosure provides examples to combine them together, which may improve the prediction accuracy and improve the coding performance.

Currently, the block vector (BV) number in the IBC tool is singular. Thus, the present disclosure provides examples to increase the block vector (BV) number and the prediction results can be combined, which may improve the prediction accuracy and improve the coding performance.

Currently, the coding block coded with Intra TMP mode is not combined with the coding block coded with intra mode or inter mode. Thus, the present disclosure provides examples to combine them together, which may improve the prediction accuracy and improve the coding performance.

Currently, the Intra TMP tool is not combined with the GPM tool. Thus, the present disclosure provides examples to combine them together, which may improve the prediction accuracy and improve the coding performance.

Currently, the IBC tool is not combined with the TIMD tool. Thus, the present disclosure provides examples to combine them together, which may improve the prediction accuracy and improve the coding performance.

Currently, the Intra TMP tool is not combined with the TIMD tool. Thus, the present disclosure provides examples to combine them together, which may improve the prediction accuracy and improve the coding performance.

Currently, the Intra TMP tool is not combined with the LIC tool. Thus, the present disclosure provides examples to combine them together, which may improve the prediction accuracy and improve the coding performance.

Currently, the IBC tool is not combined with the OBMC tool. Thus, the present disclosure provides examples to combine them together, which may improve the prediction accuracy and improve the coding performance.

Currently, the Intra TMP tool is not combined with the OBMC tool. Thus, the present disclosure provides examples to combine them together, which may improve the prediction accuracy and improve the coding performance.

In this disclosure, to address the issues as pointed out above, methods are provided to further improve the existing design of the IBC. In general, the main features of the proposed technologies in this disclosure are summarized as follows.

The IBC tool is combined with GPM tool, the combined form can be GPM with IBC and IBC prediction, GPM with IBC and Intra prediction or GPM with IBC and inter prediction.

As a simplified version of IBC tool combined with GPM tool, for a predefined direction (such as 45 degree), the upper left part is predicted with intra mode, the bottom right part is predicted with IBC mode, then they are average weighted to obtain the final prediction signal.

The IBC tool is combined with CIIP tool, where the IBC prediction is combined with intra prediction mode, or the IBC prediction is combined with inter prediction mode.

The IBC tool is combined with MHP tool, where more than one BV prediction are obtained and they are weighted averaged to obtain the final prediction signal.

The Intra TMP tool is combined with CIIP tool, where the Intra TMP is combined with intra prediction mode, or the Intra TMP is combined with inter prediction mode.

The Intra TMP tool is combined with GPM tool, the combined form can be GPM with Intra TMP and Intra TMP prediction, GPM with Intra TMP and Intra prediction or GPM with Intra TMP and inter prediction.

As a simplified version of Intra TMP tool combined with GPM tool, for a predefined direction (such as 45 degree), the upper left part is predicted with intra mode, the bottom right part is predicted with Intra TMP mode, then they are average weighted to obtain the final prediction signal.

The IBC tool is combined with TIMD tool, where IBC mode is used together with the intra prediction modes in MPMs to conduct TIMD fusion.

The Intra TMP tool is combined with TIMD tool, where Intra TMP mode is used together with the intra prediction modes in MPMs to conduct TIMD fusion.

The Intra TMP tool is combined with LIC tool, where the local illumination variation between current block and its Intra TMP prediction block is compensated with the LIC tool.

The IBC tool is combined with OBMC tool, where top and left boundary pixels of current block predicted with IBC are refined with OBMC tool.

The Intra TMP tool is combined with OBMC tool, where top and left boundary pixels of current block predicted with Intra TMP are refined with OBMC tool.

In some examples, the disclosed methods may be applied independently or jointly.

GPM with IBC and IBC Prediction

According to one or more embodiments of the disclosure, the IBC tool is combined with GPM tool in the form of GPM with IBC and IBC prediction. Different methods may be used to achieve this goal.

In the first method, both “inter” parts of GPM with inter and inter prediction method in VVC is replaced with IBC. That means that two IBC merge prediction results are weighted averaged with each other according to a splitting line in the coding block. The weight can be obtained referring to GPM with inter and inter prediction method in VVC.

In the second method, both “inter” parts of GPM with inter and inter prediction method in ECM is replaced with IBC, where some template matching tools can be utilized to further improve the coding performance.

GPM with IBC and Intra Prediction

According to one or more embodiments of the disclosure, the IBC tool is combined with GPM tool in the form of GPM with IBC and intra prediction. Different methods may be used to achieve this goal.

In the first method, the “inter” part of GPM with inter and intra prediction method in ECM is replaced with IBC, where the IBC merge predicted results are weighted averaged with the intra prediction results to obtain the final prediction signal.

GPM with IBC and Inter Prediction

According to one or more embodiments of the disclosure, the IBC tool is combined with GPM tool in the form of GPM with IBC and inter prediction. Different methods may be used to achieve this goal.

In the first method, one “inter” part of GPM with inter and inter prediction method in VVC is replaced with IBC, where the IBC merge predicted results are weighted averaged with the inter merge prediction results to obtain the final prediction signal.

In the second method, one “inter” part of GPM with inter and inter prediction method in ECM is replaced with IBC, where some template matching tools can be utilized to further improve the coding performance.

### Simplified IBC and Intra Prediction Combination in GPM Form

According to the one or more embodiments of the disclosure, the IBC tool is combined with GPM tool in the form of simplified GPM with IBC and intra prediction, such as IBC and intra prediction is combined at a certain splitting mode, which can save the bits overhead of the splitting representation. Different methods may be used to achieve this goal.

In the first method, aiming at one splitting line, such as 45 degrees, the upper left parts of the coding block is coded with intra prediction mode, and the bottom right parts of the coding block is coded with IBC prediction mode, then they are averaged in GPM form to obtain the final prediction signal.

### Combined IBC-Intra/Inter Prediction

According to one or more embodiments of the disclosure, the coding block coded with IBC mode are combined with the coding block coded with intra mode or inter mode. Different methods may be used to achieve this goal.

In the first method, the decoder/encoder may combine the coding block coded with IBC mode with the coding block coded with intra mode. Various methods can be utilized in this combination. In one example, similar to the CIIP technology in VVC, the coding block coded with IBC merge mode is regarded as the coding block coded with inter merge mode, and it is combined with the coding block coded with planar intra prediction mode. In another example, similar to the Combination of CIIP with TIMD and TM merge technology in ECM, the coding block coded with IBC merge-TM mode is combined with the coding block coded with TIMD derived intra prediction mode.

When combining the coding block coded with IBC mode with the coding block coded with intra mode, the weights may be designed similar to the CIIP technology in VVC and the Combination of CIIP with TIMD and TM merge technology in ECM, i.e. 1) the weights for both IBC coded block and intra coded block are bigger than zero and less than one, or the weights for intra coded block gradually change from one to zero from one area to another area in current block (vice versa for the weights for IBC coded block); 2) the weights for IBC coded block and intra coded block may be decided based on coding modes of neighboring blocks and intra mode of current block; 3) the weights for IBC coded block and intra coded block may be uniform in the whole current block or different in different positions of current block.

For example, the weights for IBC coded block and intra coded block may be decided as follows: When the up and left neighboring blocks of current block are both intra coded and the intra mode of current block is planar mode, the weights for IBC coded block and intra coded block are ¼ and ¾ in the whole current block. When the up and left neighboring blocks of current block are both IBC coded and the intra mode of current block is planar mode, the weights for IBC coded block and intra coded block are ¾ and ¼ in the whole current block. When one up or left neighboring block is IBC coded, the other neighboring block is intra coded, and the intra mode of current block is planar mode, the weights for IBC coded block and intra coded block are ½ and ½ in the whole current block.

When the intra mode of current block is near horizontal angular modes (2<=angular mode index <34), the current block is vertically divided as shown in FIG. 16A; when the intra mode of current block is near vertical angular modes (34<=angular mode index <=66), the current block is horizontally divided as shown in FIG. 16B. The weights for IBC coded block (wIBC) and intra coded block (wIntra) for different sub-blocks are shown in Table 7. Besides, the weights for IBC coded block and intra coded block may be decided in a CIIP-PDPC version. In this version, the intra mode of current block is set to planar mode, the weights for intra coded block gradually decrease when the combination position moves from top left to bottom right in current block, and vice versa for the weights for IBC coded block.

TABLE 7
The modified weights used for angular modes.

| The sub-block index | (wIntra, wIBC) |
|---|---|
| 0 | (6, 2) |
| 1 | (5, 3) |
| 2 | (3, 5) |
| 3 | (2, 6) |

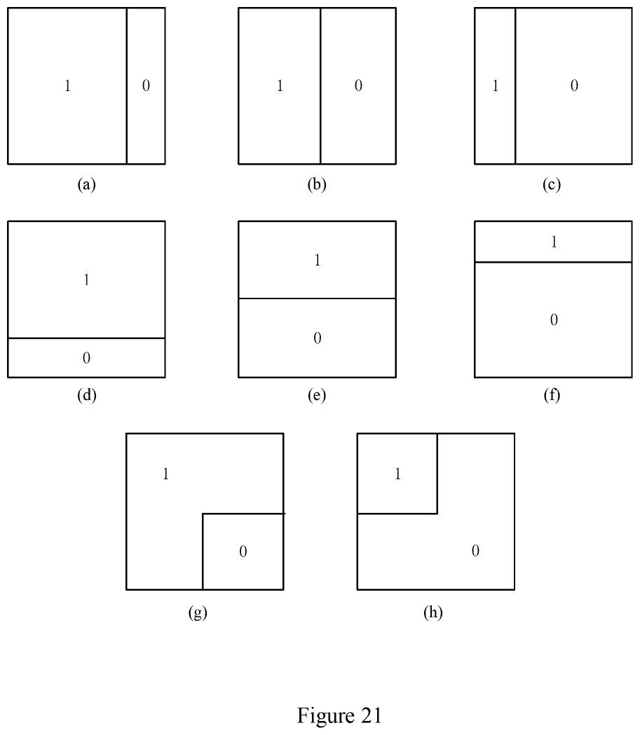

When combining the coding block coded with IBC mode with the coding block coded with intra mode, the weights may also be designed in a mask version, i.e. the weights for IBC coded block and intra coded block may be one or zero for different areas of current block. The specific weights for IBC coded block and intra coded block may be decided based on coding modes of neighboring blocks and intra mode of current block. For example, the weights for IBC coded block and intra coded block may be decided as follows: when the intra mode of current block is near horizontal angular modes (2<=angular mode index <34), if the up and left neighboring blocks of current block are both intra coded, the weights for intra coded block is one in the left ¾ area of current block and zero in the right ¼ area of current block as shown in FIG. 21 (a), and vice versa for the weights for IBC coded block; if only one neighboring block is intra coded, the weights for intra coded block is one in the left ½ area of current block and zero in the right ½ area of current block as shown in FIG. 21 (b), and vice versa for the weights for IBC coded block; if none of the up and left neighboring blocks of current block are intra coded, the weights for intra coded block is one in the left ¼ area of current block and zero in the right ¾ area of current block as shown in FIG. 21 (c), and vice versa for the weights for IBC coded block.

When the intra mode of current block is near vertical angular modes (34<=angular mode index <=66), if the up and left neighboring blocks of current block are both intra coded, the weights for intra coded block is one in the top ¾ area of current block and zero in the bottom ¼ area of current block as shown in FIG. 21 (d), and vice versa for the weights for IBC coded block; if only one neighboring block is intra coded, the weights for intra coded block is one in the top ½ area of current block and zero in the bottom ½ area of current block as shown in FIG. 21 (e), and vice versa for the weights for IBC coded block; if none of the up and left neighboring blocks of current block are intra coded, the weights for intra coded block is one in the top ¼ area of current block and zero in the bottom ¾ area of current block as shown in FIG. 21 (f), and vice versa for the weights for IBC coded block.

When the intra mode of current block is planar mode, if the up and left neighboring blocks of current block are both intra coded, the weights for intra coded block is one in the top left ¾ area (horizontal index is smaller than ½ width of current block or vertical index is smaller than ½ height of current block) of current block and zero in the right bottom ¼ area (horizontal index is equal or bigger than ½ width of current block and vertical index is equal or bigger than ½ height of current block) of current block as shown in FIG. 21 (g), and vice versa for the weights for IBC coded block; if only up neighboring block is intra coded, the weights for intra coded block is one in the top ½ area of current block and zero in the bottom ½ area of current block as shown in FIG. 21 (e), and vice versa for the weights for IBC coded block; if only left neighboring block is intra coded, the weights for intra coded block is one in the left ½ area of current block and zero in the right ½ area of current block as shown in FIG. 21 (b), and vice versa for the weights for IBC coded block; if none of the up and left neighboring blocks of current block are intra coded, the weights for intra coded block is one in the top left ¼ area (horizontal index is smaller than ½ width of current block and vertical index is smaller than ½ height of current block) of current block and zero in the bottom right ¾ area (horizontal index is equal or bigger than ½ width of current block or vertical index is equal or bigger than ½ height of current block) of current block as shown in FIG. 21 (h), and vice versa for the weights for IBC coded block.

The above two weights design methods may be utilized independently or combined together. For example, when the intra mode of current block is planar mode, if none of the up and left neighboring blocks of current block are intra coded, the weights for IBC coded block and intra coded block may be designed similar to the CIIP technology in VVC. In other conditions, the weights for IBC coded block and intra coded block may be designed in a mask version.

In the second method, the decoder/encoder may combine the coding block coded with IBC mode with the coding block coded with inter mode. Various methods may be utilized in this combination. In one example, similar to the CIIP technology in VVC, the coding block coded with IBC merge mode is regarded as the coding block coded with planar intra mode, and it is combined with the coding block coded with inter merge mode. In another example, the coding block coded with IBC merge mode is regarded as the coding block coded with inter merge mode, and it is combined with the coding block coded with inter merge mode by equally averaging.

In the third method, the decoder/encoder may combine the coding block coded with IBC mode with the coding block coded with intra mode and the coding block coded with inter mode. Various methods may be utilized in this combination. In one example, the coding block coded with IBC mode, the coding block coded with intra mode, and the coding block coded with inter mode are directly combined by equally averaging. In another example, firstly the coding block coded with IBC mode is separately combined with the coding block coded with intra mode and inter mode as presented in the first and second method. Then, the separate combined results are combined by equally averaging.

### Multiple Hypothesis IBC Prediction

According to the one or more embodiments of the disclosure, the block vector (BV) number in IBC tool is increased to 2 or more, and 2 or more hypotheses are combined to obtain the final prediction result. Different methods may be used to achieve this goal.

In the first method, the decoder/encoder may combine 2 hypotheses corresponding to 2 BVs to obtain the final prediction result. Various methods may be utilized to achieve this goal. In one example, the 2 BVs corresponding to the smallest and the second smallest rate distortion metrics in IBC AMVP mode are equally averaged to obtain the final prediction result. In another example, the prediction result corresponding to IBC AMVP mode and the prediction result corresponding to IBC merge mode are equally averaged to obtain the final prediction result.

In the second method, the decoder/encoder may combine more hypothesis corresponding to more BVs to obtain the final prediction result. Various methods may be utilized to achieve this goal. In one example, the iterative accumulation method proposed in Multi-hypothesis prediction (MHP) technology is utilized to obtain the final prediction result. In another example, all the BVs corresponding the smallest, the second smallest, the third smallest, . . . , rate distortion metrics in IBC AMVP mode are equally averaged to obtain the final prediction result.

### Prediction Block Candidate Derivation

In some embodiments, the prediction block candidates are searched and selected according to the criterion of minimizing template matching cost, i.e., the top N candidates which lead to the minimum block vector (BV) matching cost are selected. The BV matching cost can be not limited to SAD (sum of absolute difference) and SSE (sum of square error). In some embodiments, template matching cost or BV matching cost may be computed based on comparison of distortion of the corresponding reference with neighboring blocks, such as a top neighboring block or a left neighboring block.

In some embodiments, the prediction block candidates may be selected according to the predefined mode, i.e., planar mode.

In some embodiments, the prediction block candidates may be selected according to the neighbor predefined mode, i.e., top predefined mode, left predefined mode. In some examples, the top predefined mode of the current block inherits a predefined mode of a top neighbor block of the current block, and the left predefined mode inherits a predefined mode of a left neighbor block of the current block.

### Fixed Multi-Hypothesis IBC

In this embodiment, the weighting factors to generate the final prediction block are predefined and fixed at both the encoder and decoder side. As an example, equal weighting factors can be used, i.e., 1/N for all the candidate blocks.

### Adaptive Multi-Hypothesis IBC

To adapt to the diverse characteristics of video content, adaptive multi-hypothesis IBC methods are also proposed.

In some embodiments, the weighting factors may be derived based on the BV matching costs. Denote the BV matching costs of the N candidates as C₁, C₂, . . . , C_{N}, the weighting factors are calculated as follow.

$${ω}_{i} = \frac{1}{N - 1} - \frac{{C}_{i}}{( N - 1 ) {\sum }_{k = 1}^{N} {C}_{k}} , i = 1 , 2 , … , N \qquad ( 19 )$$

It should be noted that the BV matching cost can be measured with (but not limited to) SAD and SSE.

In yet another embodiment, the weighting factors may be derived/switched based on the block size or syntax element signaled in SPS/DPS/VPS/SEI/APS/PPS/PH/SH/Region/CTU/CU/Subblock/Sample levels.

In yet another embodiment, the weighting factors may be derived at the encoder side and then signaled in the bitstream to the decoder. Denote the N prediction block candidates as P₁, P₂, . . . , P_{N} and the current block as X, then the weighting factors can be solved by the following equation:

$${\sum }_{i = 1}^{N} {ω}_{i} {P}_{i} = X \qquad ( 20 )$$

Equation (20) may be solved using Wiener-Hopf equations as ALF. The derived filter coefficients are then quantized to integer type and signaled in the block level.

In yet another embodiment, the weighting factors may be derived at the encoder side and then signaled in the bitstream to the decoder. Denote the N prediction block candidates as P₁, P₂, . . . , P_{N} and the current block as X, then the weighting factors may be solved by the following equation:

$${\sum }_{i = 1}^{N} {ω}_{i} {P}_{i} = X \qquad ( 21 )$$

Equation (21) may be solved using LDL decomposition or Gaussian elimination.

In yet another embodiment, the weighting factors are derived based on the templates and the derived weighting factors are applied to the prediction block candidates to generate the final prediction block. Denote the templates of the prediction candidates as T₁, T₂, . . . , T_{N} and the current block as T, then the weighting factors can be derived using the following equation:

$${\sum }_{i = 1}^{N} {ω}_{i} {T}_{i} = T \qquad ( 22 )$$

Equation (22) may be solved using Wiener-Hopf equations. Then the final prediction block can be calculated as

$${\sum }_{i = 1}^{N} {ω}_{i} {P}_{i} ,$$

where Pᵢ represents the i-th prediction block candidate.

IBC mode exploits the nonlocal correlation to improve the prediction accuracy, in which similar blocks are searched and used to generate the final prediction block. In this embodiment, it is provided to combine the nonlocal mean filtering and multi-hypothesis IBC, which is described as follow. In some examples, nonlocal mean filtering is an algorithm in image processing for image denoising, where the algorithm, when executed, takes a mean of all pixels in a image, weighted by how similar the pixels are to a target pixel. In the first step, N prediction block candidates are searched and identified as conducted in the IBC. In the second step, the weighting factor is calculated as follows.

$${ω}_{i} = \frac{1}{Z [ i ]} {e}^{- \frac{{D}_{i}}{{h}^{2}}} \qquad ( 23 )$$

Where Dᵢ is used to measure the distance between the template of the i-th prediction block candidate and the template of the current block, h is used as the degree of weighting or strength of weighting and Z[i] is the normalization constant:

$$Z [ i ] = {\sum }_{i = 1}^{N} {e}^{- \frac{{D}_{i}}{{h}^{2}}} \qquad ( 24 )$$

To calculate the weighting factor in equation (23), the strength of weighting should be determined first. In this disclosure, several methods are proposed to decide the weighting strength or strength of weighting.

In the first method, a weighting strength candidate list including some typical weighting strength values is defined and fixed at both encoder and decoder side. At the encoder side, the weighting strength values are checked using rate distortion optimization and the optimal weighting strength value is identified and signaled in the bitstream to the decoder side.

In the second method, the weighting strength value is estimated using the template of the prediction block candidates and the template of the current block. Denote the templates of the prediction candidates as T₁, T₂, . . . , T_{N} and the current block as T. Then the weighting strength value can be solved using the following equation:

$${\sum }_{i = 1}^{N} {ω}_{i} {T}_{i} = {\sum }_{i = 1}^{N} \frac{1}{Z [ i ]} {e}^{- \frac{{D}_{i}}{{h}^{2}}} {T}_{i} = T \qquad ( 25 )$$

In the third method, the weighting strength value can be estimated using the QP value and variance of the template of the current block, i.e., the relationship between the weighting strength value, QP value and the template variance can be fitted offline.

To better exploit the nonlocal correlation in the IBC, in this embodiment singular value decomposition (SVD) is utilized to generate the final prediction block from the prediction block candidates. The width and height of the current block are denoted as W and H, the area of the current block is denoted as d=H×W.

Step1. K prediction block candidates yᵢ are searched and identified as conducted in the FIBC.

Step2. The K prediction block candidates of the current block y construct the block group G and are arranged as a matrix:

$${Y}_{G} = [ {y}_{G}^{( 1 )} , {y}_{G}^{( 2 )} , … , {y}_{G}^{( K )} ] \qquad ( 26 )$$

Where Y_{G} is a matrix with size of d×K by arranging every candidate in group G as a column vector.

Step3. Perform SVD decomposition on the matrix Y_{G}.

$$SVD ( {Y}_{G} ) = {U}_{G} {Λ}_{G} {V}_{G}^{*} \qquad ( 27 )$$

Step4. Apply soft-thresholding operation on the singular value matrix Λ_{G}.

$${Λ}_{{G}_{i} , τ} = softTh ( {Λ}_{G} , τ ) \qquad ( 28 )$$

Where softTh( ) is a function which shrinks the diagonal elements of Λ_{G} with the threshold τ. For the k-th diagonal element in Λ_{G}, it is shrunken by the nonlinear function D_{τ(k)} at level τ(k):

$${D}_{τ ( k )} : {λ}_{k , τ ( k )} = max ( \vert {λ}_{k} \vert - τ ( k ) , 0 ) \qquad ( 29 )$$

Λ_{G,τ} is the matrix composed of the shrunken singular values, λ_{k,τ(k)} at diagonal positions.

Step5. Perform inverse SVD to obtain the filtered patch group.

$${\hat{X}}_{G} = {U}_{G} {Λ}_{G , τ} {V}_{G}^{*} \qquad ( 30 )$$

One of the key steps is to determine the thresholding values for each diagonal elements in step 4. In the present disclosure, the thresholding values are calculated as follows. The threshold is estimated for each group of image patches with the following equation:

$${τ}_{G} ( k ) = c \times \frac{{σ}_{n , G}^{2}}{{σ}_{x , G , k}} \qquad ( 31 )$$

Where σ_{n,G} is the standard deviation of noise, and σ_{x,G,k} is the standard deviation of the original block in the k-th dimension of SVD space for group G. The deviation of the original block in SVD space is estimated as follow.

$${σ}_{x , G , k} = \sqrt{max ( \frac{{λ}_{G , k}^{2}}{min ( d , K )} - ω \times {σ}_{n , G}^{2} , 0 )} \qquad ( 32 )$$

Where

$${λ}_{G , k}^{2}$$

is the k-th singular value of Y_{G}_{ᵢ}. When σ_{x,G,k} is zero, the soft-thresholding operation is skipped. In addition, the deviation of noise is estimated with the deviation of the predicted block using a power function which is parameterized with α and β.

$${σ}_{n} = α \times {σ}_{y}^{β} \qquad ( 33 )$$

Where σ_{y} is calculated as follows,

$${σ}_{y} = \frac{1}{K} {\sum }_{k =}^{K} 0 \sqrt[2]{{\sum }_{i = 1}^{{p}^{2}} \frac{{( {y}_{k} ( i ) - {μ}_{k} )}^{2}}{{p}^{2}}} , {μ}_{k} = \frac{1}{{p}^{2}} {\sum }_{i = 1}^{{p}^{2}} {y}_{k} ( i ) \qquad ( 34 )$$

Here yₖ(i) represents the i-th pixel of prediction block candidate vector yₖ.

### Multi-Hypothesis IBC Signaling

In this disclosure, the proposed multi-hypothesis IBC can be utilized as a replacement of the current IBC mode or the encoder can adaptively select IBC mode or multi-hypothesis IBC mode.

In some embodiments, the multi-hypothesis IBC may be used as a replacement of the current IBC mode, i.e., always using multiple hypothesis for prediction.

In yet another embodiment, one of the multi-hypothesis IBC methods in the above sections is used jointly with the current IBC mode. A flag is signaled in the bitstream to indicate whether multi-hypothesis IBC mode is applied to the CU.

In yet another embodiment, more than one multi-hypothesis IBC methods in the above sections are used jointly with the current IBC mode. A flag is firstly signaled in the bitstream to indicate whether multi-hypothesis IBC mode is applied. Then an index is signaled to indicate which of the multi-hypothesis IBC methods is applied to the CU.

In yet another embodiment, multi-hypothesis IBC method in the above sections is used jointly with the current IBC mode. The multi-hypothesis IBC may be used as a replacement of the current IBC mode according to certain coded information of the current block, e.g., SAD (sum of absolute difference), SSE (sum of square error), quantization parameter (QP) associated with the TB/CB and/or the slice, the neighbor prediction modes of the CU (e.g., IBC mode or intra or inter) and/or the slice type (e.g. I slice, P slice or B slice).

### Combined Intra TMP-Intra/Inter Prediction

According to one or more embodiments of the disclosure, the coding block coded with Intra TMP mode are combined with the coding block coded with intra mode or inter mode. Different methods may be used to achieve this goal.

In the first method, the decoder/encoder may combine the coding block coded with Intra TMP mode with the coding block coded with intra mode. Various methods may be utilized in this combination. In one example, similar to the CIIP technology in VVC, the coding block coded with Intra TMP mode is regarded as the coding block coded with inter merge mode, and it is combined with the coding block coded with planar intra prediction mode. In another example, similar to the Combination of CIIP with TIMD and TM merge technology in ECM, the coding block coded with Intra TMP mode is combined with the coding block coded with TIMD derived intra prediction mode.

In the second method, the decoder/encoder may combine the coding block coded with Intra TMP mode with the coding block coded with inter mode. Various methods may be utilized in this combination. In one example, similar to the CIIP technology in VVC, the coding block coded with Intra TMP mode is regarded as the coding block coded with planar intra mode, and it is combined with the coding block coded with inter merge mode. In another example, the coding block coded with Intra TMP mode is regarded as the coding block coded with inter merge mode, and it is combined with the coding block coded with inter merge mode by equally averaging.

In the third method, the decoder/encoder may combine the coding block coded with Intra TMP mode with the coding block coded with intra mode and the coding block coded with inter mode. Various methods may be utilized in this combination. In one example, the coding block coded with Intra TMP mode, the coding block coded with intra mode, and the coding block coded with inter mode are directly combined by equally averaging. In another example, firstly the coding block coded with Intra TMP mode is separately combined with the coding block coded with intra mode and inter mode as presented in the first and second method. Then, the separate combined results are combined by equally averaging.

GPM with Intra TMP and Intra TMP Prediction

According to one or more embodiments of the disclosure, the Intra TMP tool is combined with GPM tool in the form of GPM with Intra TMP and Intra TMP prediction. Different methods may be used to achieve this goal.

In the first method, both “inter” parts of GPM with inter and inter prediction method in VVC is replaced with Intra TMP. That means that two Intra TMP prediction results are weighted averaged with each other according to a splitting line in the coding block. The weight may be obtained referring to GPM with inter and inter prediction method in VVC.

In the second method, both “inter” parts of GPM with inter and inter prediction method in ECM is replaced with Intra TMP, where some template matching tools may be utilized to further improve the coding performance.

GPM with Intra TMP and Intra Prediction

According to one or more embodiments of the disclosure, the Intra TMP tool is combined with GPM tool in the form of GPM with Intra TMP and intra prediction. Different methods may be used to achieve this goal.

In the first method, the “inter” part of GPM with inter and intra prediction method in ECM is replaced with Intra TMP, where the Intra TMP predicted results are weighted averaged with the intra prediction results to obtain the final prediction signal.

GPM with Intra TMP and Inter Prediction

According to one or more embodiments of the disclosure, the Intra TMP tool is combined with GPM tool in the form of GPM with Intra TMP and inter prediction. Different methods may be used to achieve this goal.

In the first method, one “inter” part of GPM with inter and inter prediction method in VVC is replaced with Intra TMP, where the Intra TMP predicted results are weighted averaged with the inter merge prediction results to obtain the final prediction signal.

In the second method, one “inter” part of GPM with inter and inter prediction method in ECM is replaced with Intra TMP, where some template matching tools may be utilized to further improve the coding performance.

### Simplified Intra TMP and Intra Prediction Combination in GPM Form

According to one or more embodiments of the disclosure, the Intra TMP tool is combined with GPM tool in the form of simplified GPM with Intra TMP and intra prediction, such as Intra TMP and intra prediction is combined at a certain splitting mode, which may save the bits overhead of the splitting representation. Different methods may be used to achieve this goal.

In the first method, aiming at one splitting line, such as 45 degrees, the upper left parts of the coding block is coded with intra prediction mode, and the bottom right parts of the coding block is coded with Intra TMP prediction mode, then they are averaged in GPM form to obtain the final prediction signal.

Combine IBC with TIMD Mode

According to the one or more embodiments of the disclosure, the IBC tool is combined with TIMD tool. Different methods may be used to achieve this goal.

In the first method, the IBC mode is regarded as one intra prediction mode added in the MPM list, then the IBC mode is compared with other intra prediction modes in the MPM list using template matching cost, finally two modes with the minimum and second minimum costs are fused using TIMD method to obtain the final prediction result.

In the second method, first the regular TIMD prediction result is obtained, then the template matching cost of the IBC mode and the regular TIMD prediction result are calculated, finally the IBC mode and the regular TIMD prediction result are fused using TIMD method to obtain the final prediction result.

Combine Intra TMP with TIMD Mode

According to the one or more embodiments of the disclosure, the Intra TMP tool is combined with TIMD tool. Different methods may be used to achieve this goal.

In the first method, the Intra TMP mode is regarded as one intra prediction mode added in the MPM list, then the Intra TMP mode is compared with other intra prediction modes in the MPM list using template matching cost, finally two modes with the minimum and second minimum costs are fused using TIMD method to obtain the final prediction result.

In the second method, first the regular TIMD prediction result is obtained, then the template matching cost of the Intra TMP mode and the regular TIMD prediction result are calculated, finally the Intra TMP mode and the regular TIMD prediction result are fused using TIMD method to obtain the final prediction result.

Combine Intra TMP with LIC

According to the one or more embodiments of the disclosure, the Intra TMP tool is combined with LIC tool. Different methods may be used to achieve this goal.

In the first method, the Intra TMP mode is regarded as inter mode, and LIC is used to model local illumination variation between current block and its Intra TMP prediction block as a function of that between current block template and reference block template. The function is a linear equation as used in the regular LIC method.

Combine IBC with OBMC

According to the one or more embodiments of the disclosure, the IBC tool is combined with OBMC tool. Different methods may be used to achieve this goal.

In the first method, the IBC mode is regarded as inter mode, and the regular OBMC method is applied to refine the top and left boundary pixels of an IBC coded CU using neighboring block's block vector information with a weighted prediction.

In the second method, the IBC mode is regarded as inter mode, and the template matching based OBMC method is applied to refine the top and left boundary pixels of an IBC coded CU using template matching based methods.

Combine Intra TMP with OBMC

According to the one or more embodiments of the disclosure, the Intra TMP tool is combined with OBMC tool. Different methods may be used to achieve this goal.

In the first method, the Intra TMP mode is regarded as inter mode, and the regular OBMC method is applied to refine the top and left boundary pixels of an Intra TMP coded CU using neighboring block's block vector information with a weighted prediction.

In the second method, the Intra TMP mode is regarded as inter mode, and the template matching based OBMC method is applied to refine the top and left boundary pixels of an Intra TMP coded CU using template matching based methods.

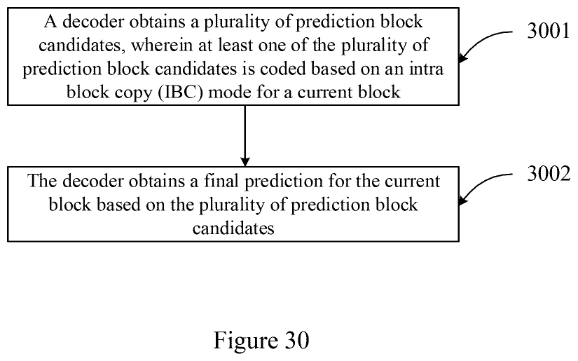

FIG. 30 is a flowchart illustrating a method for video decoding according to an example of the present disclosure.

In Step 3001, the processor 2920, at the side of a decoder, may obtain a plurality of prediction block candidates, where at least one of the plurality of prediction block candidates is coded based on an intra block copy (IBC) mode for a current block.

In Step 3002, the processor 2920 may obtain a final prediction for the current block based on the plurality of prediction block candidates.

In some examples, the processor 2920 may further obtain a plurality of weights corresponding to the plurality of prediction block candidates, and in Step 3002, the processor may obtain the final prediction for the current block based on the plurality of prediction block candidates and the plurality of weights.

In some examples, the processor 2920 may, in Step 3001, search for a plurality of block candidates, where block vector (BV) matching costs of the plurality of the block candidates are lower than the BV matching costs of other block candidates. Additionally, the processor 2920 may, in Step 3001, select the plurality of block candidates as the plurality of prediction block candidates. In some examples, the BV matching costs may be measured with one of sum of absolute difference (SAD) or sum of square error (SSE). In some examples, the BV matching cost may be computed based on comparison of distortion of the corresponding reference with neighboring blocks, such as a top neighboring block or a left neighboring block.

In some examples, the processor 2920 may, in Step 3001, select the plurality of block candidates based on a predefined mode, where the predefined mode may include a planar mode.

In some examples, the processor 2920 may, in Step 3001, select the plurality of block candidates based on a predefined mode of neighboring blocks, where the predefined mode of neighboring blocks may include one of a top predefined mode or a left predefined mode. In some examples, the top predefined mode of the current block inherits a predefined mode of a top neighbor block of the current block, and the left predefined mode inherits a predefined mode of a left neighbor block of the current block.

In some examples, to obtain the plurality of weights corresponding to the plurality of prediction block candidates, the processor 2920 may set each of the plurality of weights to be a reciprocal of an integer N, where N is a number of the plurality of prediction block candidates.

In some examples, to obtain the plurality of weights corresponding to the plurality of prediction block candidates, the processor 2920 may derive the plurality of weights based on a plurality of block vector (BV) matching costs. In some examples, to obtain the plurality of weights corresponding to the plurality of prediction block candidates, the processor 2920 may further obtain a plurality of prediction BV matching costs of the plurality of prediction block candidates as the plurality of BV matching costs. In some examples, the plurality of BV matching costs are measured with one of sum of absolute difference (SAD) or sum of square error (SSE).

In some examples, to obtain the plurality of weights corresponding to the plurality of prediction block candidates, the processor 2920 may derive the plurality of weights based on a block size of the current block or a syntax element signaled by an encoder, where the syntax element is signaled in one of following levels: Sequence Parameter Set (SPS), Decoded Picture Set (DPS), Video Parameter Set (VPS), Supplemental Enhancement Information (SEI), Adaptation Parameter Set (APS), Picture Parameter Set (PPS), picture header (PH), slice header (SH), Region, Coding Tree Unit (CTU), Coding Unit (CU), Subblock, or Sample level.

In some examples, to obtain the plurality of weights corresponding to the plurality of prediction block candidates, the processor 2920 may receive the plurality of weights signaled in a bitstream by an encoder.

In some examples, to obtain the plurality of weights corresponding to the plurality of prediction block candidates, the processor 2920 may obtain the plurality of weights based on a plurality of templates. In some examples, to obtain the plurality of weights corresponding to the plurality of prediction block candidates, the processor 2920 may further obtain a plurality of prediction block templates of the plurality of prediction block candidates as the plurality of templates; additionally, to obtain the plurality of weights corresponding to the plurality of prediction block candidates, the processor 2920 may obtain a current block template of the current block. Moreover, to obtain the plurality of weights based on the plurality of templates, the processor 2920 may obtain the plurality of weights based on the plurality of prediction block templates and the current block template.

In some examples, to obtain the plurality of weights corresponding to the plurality of prediction block candidates, the processor 2920 may further obtain, using nonlocal mean filtering, the plurality of weights. In some examples, to obtain, using the nonlocal mean filtering, the plurality of means, the processor 2920 may obtain a plurality of distances based on the plurality of prediction block candidates and the current block; additionally, to obtain, using the nonlocal mean filtering, the plurality of means, the processor 2920 may obtain the plurality of weights based on the plurality of distances and a strength of weighting. In some examples, the processor 2920 may further determine the strength of weighting. In some examples, the nonlocal mean filtering is an algorithm in image processing for image denoising, where the algorithm, when executed, takes a mean of all pixels in a image, weighted by how similar the pixels are to a target pixel.

In some examples, to determine the strength of weighting, the processor 2920 may define and fix a weighting strength candidate list comprising a plurality of typical weighting strength values, and select a typical weight strength value as an optimal weighting strength value based on a flag signaled in a bitstream. Alternatively or additionally, the processor 2920 may receive an optimal weighting strength value signaled in a bitstream.

In some examples, to determine the strength of weighting, the processor 2920 may obtain a plurality of prediction CU templates of the plurality of prediction CU candidates, obtain a current CU template of the current CU, and estimate the strength of weighting based on the plurality of prediction CU templates and the current CU template.

In some examples, to determine the strength of weighting, the processor 2920 may estimate the strength of weighting, using a Quantization Parameter (QP) value and a variance of a current CU template of the current CU.

In some examples, in Step 3002, the processor 2920 may perform singular value decomposition (SVD) on a matrix generated from the plurality of prediction block candidates; additionally, in Step 3002, the processor 2920 may obtain the final prediction based on results of performing the SVD.

In some examples, the processor 2920 may further receive a flag signaled in a bitstream, wherein the flag indicates whether a multi-hypothesis IBC mode is applied to the current block. In some examples, the processor 2920 may, in response to determining that the flag indicates that the multi-hypothesis IBC mode is applied to the current block, further receive an index signaled in the bitstream, where the index indicates a multi-hypothesis IBC method applied to the current block.

In some examples, the processor 2920 may further determine, based on coded information, that multi-hypothesis IBC mode is applied to the current block, where the coded information includes at least one of following information: sum of absolute difference (SAD), sum of square error (SSE), Quantization Parameter (QP), neighbor prediction modes of the current block, or a slice type.

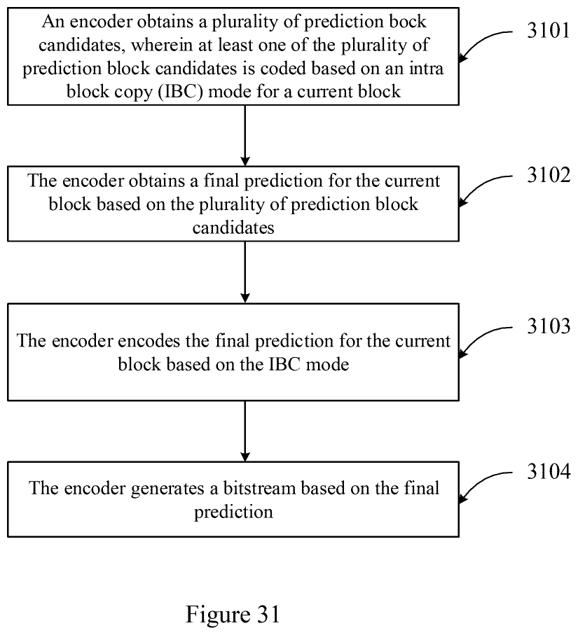

FIG. 31 is a flowchart illustrating a method for video encoding corresponding the method for video decoding as shown in FIG. 30.

In Step 3101, the processor 2920, at the side of an encoder, may obtain a plurality of prediction block candidates, where at least one of the plurality of prediction block candidates is coded based on an intra block copy (IBC) mode for a current block.

In Step 3102, the processor 2920 may obtain a final prediction for the current block based on the plurality of prediction block candidates.

In Step 3103, the processor 2920 may obtain the final prediction for the current block based on the IBC mode.

In Step 3104, the processor 2920 may generate a bitstream based on the final prediction.

In some examples, at least one of the plurality of prediction block candidates is coded based on the IBC mode for the current block. In some examples, the processor 2920 may further obtain a plurality of weights corresponding to the plurality of prediction block candidates, and in Step 3102, the processor may obtain the final prediction for the current block based on the plurality of prediction block candidates and the plurality of weights.

In some examples, the processor 2920 may, in Step 3101, search for a plurality of block candidates, where block vector (BV) matching costs of the plurality of the block candidates are lower than the BV matching costs of other block candidates. Additionally, the processor 2920 may, in Step 3101, select the plurality of block candidates as the plurality of prediction block candidates. In some examples, the BV matching costs may be measured with one of sum of absolute difference (SAD) or sum of square error (SSE). In some examples, the BV matching cost may be computed based on comparison of distortion of the corresponding reference with neighboring blocks, such as a top neighboring block or a left neighboring block.

In some examples, the processor 2920 may, in Step 3101, select the plurality of block candidates based on a predefined mode, where the predefined mode may include a planar mode.

In some examples, the processor 2920 may, in Step 3101, select the plurality of block candidates based on a predefined mode of neighboring blocks, where the predefined mode of neighboring blocks may include one of a top predefined mode or a left predefined mode. In some examples, the top predefined mode of the current block inherits a predefined mode of a top neighbor block of the current block, and the left predefined mode inherits a predefined mode of a left neighbor block of the current block.

In some examples, to obtain the plurality of weights corresponding to the plurality of prediction block candidates, the processor 2920 may set each of the plurality of weights to be a reciprocal of an integer N, where N is a number of the plurality of prediction block candidates.

In some examples, to obtain the plurality of weights corresponding to the plurality of prediction block candidates, the processor 2920 may derive the plurality of weights based on a plurality of block vector (BV) matching costs. In some examples, to obtain the plurality of weights corresponding to the plurality of prediction block candidates, the processor 2920 may further obtain a plurality of prediction BV matching costs of the plurality of prediction block candidates as the plurality of BV matching costs. In some examples, the plurality of BV matching costs are measured with one of sum of absolute difference (SAD) or sum of square error (SSE).

In some examples, to obtain the plurality of weights corresponding to the plurality of prediction block candidates, the processor 2920 may further signal, to a decoder, the plurality of weights based on a block size of the current block or a syntax element signaled by an encoder, where the syntax element is signaled in one of following levels: Sequence Parameter Set (SPS), Decoded Picture Set (DPS), Video Parameter Set (VPS), Supplemental Enhancement Information (SEI), Adaptation Parameter Set (APS), Picture Parameter Set (PPS), picture header (PH), slice header (SH), Region, Coding Tree Unit (CTU), Coding Unit (CU), Subblock, or Sample level.

In some examples, to obtain the plurality of weights corresponding to the plurality of prediction block candidates, the processor 2920 may obtain the plurality of weights based on the plurality of prediction block candidates and the current block; additionally, to obtain the plurality of weights corresponding to the plurality of prediction block candidates, the processor 2920 may signal, in a bitstream, the plurality of weights.

In some examples, to obtain the plurality of weights corresponding to the plurality of prediction block candidates, the processor 2920 may obtain the plurality of weights based on a plurality of templates. In some examples, to obtain a plurality of weights corresponding to the plurality of prediction block candidates, the processor 2920 may further obtain a plurality of prediction block templates of the plurality of prediction block candidates as the plurality of templates; additionally, to obtain the plurality of weights corresponding to the plurality of prediction block candidates, the processor 2920 may obtain a current block template of the current block. Moreover, to obtain the plurality of weights based on the plurality of templates, the processor 2920 may obtain the plurality of weights based on the plurality of prediction block templates and the current block template.

In some examples, to obtain the plurality of weights corresponding to the plurality of prediction block candidates, the processor 2920 may further obtain, using nonlocal mean filtering, the plurality of weights. In some examples, to obtain, using the nonlocal mean filtering, the plurality of means, the processor 2920 may obtain a plurality of distances based on the plurality of prediction block candidates and the current block; additionally, to obtain, using the nonlocal mean filtering, the plurality of means, the processor 2920 may obtain the plurality of weights based on the plurality of distances and a strength of weighting. In some examples, the processor 2920 may further determine the strength of weighting. In some examples, the nonlocal mean filtering is an algorithm in image processing for image denoising, where the algorithm, when executed, takes a mean of all pixels in a image, weighted by how similar the pixels are to a target pixel.

In some examples, to determine the strength of weighting, the processor 2920 may define and fix a weighting strength candidate list comprising a plurality of typical weighting strength values, check the plurality of typical weighting strength values using rate distortion optimization, identify an optimal weighting strength value, and signal, in a bitstream, the optimal weighting strength value.

In some examples, to determine the strength of weighting, the processor 2920 may obtain a plurality of prediction CU templates of the plurality of prediction CU candidates, obtain a current CU template of the current CU, and estimate the strength of weighting based on the plurality of prediction CU templates and the current CU template.

In some examples, to determine the strength of weighting, the processor 2920 may estimate the strength of weighting, using a Quantization Parameter (QP) value and a variance of a current CU template of the current CU.

In some examples, in Step 3102, the processor 2920 may perform singular value decomposition (SVD) on a matrix generated from the plurality of prediction block candidates; additionally, in Step 3102, the processor 2920 may obtain the final prediction based on results of performing the SVD.

In some examples, the processor 2920 may further set a flag signaled in a bitstream, wherein the flag indicates whether a multi-hypothesis IBC mode is applied to the current block. In some examples, the processor 2920 may, in response to determining that the flag indicates that the multi-hypothesis IBC mode is applied to the current block, further set an index signaled in the bitstream, where the index indicates a multi-hypothesis IBC method applied to the current block.

In some examples, the processor 2920 may further determine, based on coded information, that multi-hypothesis IBC mode is applied to the current block, where the coded information includes at least one of following information: sum of absolute difference (SAD), sum of square error (SSE), Quantization Parameter (QP), neighbor prediction modes of the current block, or a slice type.

In some examples, there is provided an apparatus for video coding. The apparatus includes a processor 2920 and a memory 2930 coupled to the processor 2920 configured to store instructions executable by the processor; where the processor 2920, upon execution of the instructions, is configured to perform any method as illustrated in FIGS. 30-31. To perform the method as illustrated in FIG. 30, the memory 2930 is further configured to store a bitstream. To perform the method as illustrated in FIG. 31, the processor 2920, upon execution of the instructions, is further configured to generate a bitstream and to store the bitstream in the memory.

In an embodiment, there is also provided a non-transitory computer-readable storage medium comprising a plurality of programs, for example, in the memory 2930, executable by the processor 2920 in the computing environment 2910, for performing the above-described methods and/or storing a bitstream generated by the encoding method described above or a bitstream to be decoded by the decoding method described above. In one example, the plurality of programs may be executed by the processor 2920 in the computing environment 2910 to receive (for example, from the video encoder 20 in FIG. 2) a bitstream or data stream including encoded video information (for example, video blocks representing encoded video frames, and/or associated one or more syntax elements, etc.), and may also be executed by the processor 2920 in the computing environment 2910 to perform the decoding method described above according to the received bitstream or data stream. In another example, the plurality of programs may be executed by the processor 2920 in the computing environment 2910 to perform the encoding method described above to encode video information (for example, video blocks representing video frames, and/or associated one or more syntax elements, etc.) into a bitstream or data stream, and may also be executed by the processor 2920 in the computing environment 2910 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 2920); and the non-transitory computer-readable storage medium or the memory 2930 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 2930, executable by the processor 2920 in the computing environment 2910, for performing the above-described methods. For example, the computer program product may include the non-transitory computer-readable storage medium.

In an embodiment, the computing environment 2910 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

### EXAMPLES

Illustrative examples of the disclosed technologies are provided below. An embodiment may include any one or more of these examples, or any combination thereof.

Example 1 includes a method for video decoding, comprising: obtaining, by a decoder, a plurality of prediction block candidates, wherein at least one of the plurality of prediction block candidates is coded based on an intra block copy (IBC) mode for a current block; and obtaining, by the decoder, a final prediction for the current block based on the plurality of prediction block candidates.

Example 2 includes the subject matter of example 1, further comprising: obtaining, by the decoder, a plurality of weights corresponding to the plurality of prediction block candidates; and wherein obtaining, by the decoder, the final prediction for the current block based on the plurality of prediction block candidates comprises: obtaining, by the decoder, the final prediction for the current block based on the plurality of prediction block candidates and the plurality of weights.

Example 3 includes the subject matter of example 1, wherein obtaining, by the decoder, the plurality of prediction block candidates comprises: searching, by the decoder, a plurality of block candidates, wherein block vector (BV) matching costs of the plurality of the block candidates are lower than the BV matching costs of other block candidates; and selecting, by the decoder, the plurality of block candidates as the plurality of prediction block candidates.

Example 4 includes the subject matter of example 3, wherein the BV matching costs are measured with one of sum of absolute difference (SAD) or sum of square error (SSE).

Example 5 includes the subject matter of example 1, wherein obtaining, by the decoder, the plurality of prediction block candidates comprises: selecting, by the decoder, the plurality of block candidates based on a predefined mode; wherein the predefined mode comprises a planar mode.

Example 6 includes the subject matter of example 1, wherein obtaining, by the decoder, the plurality of prediction block candidates comprises: selecting, by the decoder, the plurality of block candidates based on a predefined mode of neighboring blocks; wherein the predefined mode of neighboring blocks comprises one of a top predefined mode or a left predefined mode.

Example 7 includes the subject matter of example 2, wherein obtaining, by the decoder, the plurality of weights corresponding to the plurality of prediction block candidates comprises: setting, by the decoder, each of the plurality of weights to be a reciprocal of an integer N, wherein N is a number of the plurality of prediction block candidates.

Example 8 includes the subject matter of example 2, wherein obtaining, by the decoder, the plurality of weights corresponding to the plurality of prediction block candidates comprises: deriving, by the decoder, the plurality of weights based on a plurality of block vector (BV) matching costs.

Example 9 includes the subject matter of example 8, wherein obtaining, by the decoder, the plurality of weights corresponding to the plurality of prediction block candidates further comprises: obtaining, by the decoder, a plurality of prediction BV matching costs of the plurality of prediction block candidates as the plurality of BV matching costs.

Example 10 includes the subject matter of example 8, wherein the plurality of BV matching costs are measured with one of sum of absolute difference (SAD) or sum of square error (SSE).

Example 11 includes the subject matter of example 2, wherein obtaining, by the decoder, the plurality of weights corresponding to the plurality of prediction block candidates comprises: deriving, by the decoder, the plurality of weights based on a block size of the current block or a syntax element; wherein the syntax element is signaled in one of following levels: Sequence Parameter Set (SPS), Decoded Picture Set (DPS), Video Parameter Set (VPS), Supplemental Enhancement Information (SEI), Adaptation Parameter Set (APS), Picture Parameter Set (PPS), picture header (PH), slice header (SH), Region, Coding Tree Unit (CTU), Coding Unit (CU), Subblock, or Sample level.

Example 12 includes the subject matter of example 2, wherein obtaining, by the decoder, the plurality of weights corresponding to the plurality of prediction block candidates comprises: receiving, by the decoder, the plurality of weights signaled in a bitstream.

Example 13 includes the subject matter of example 2, wherein obtaining, by the decoder, the plurality of weights corresponding to the plurality of prediction block candidates comprises: obtaining, by the decoder, the plurality of weights based on a plurality of templates.

Example 14 includes the subject matter of example 2, wherein obtaining, by the decoder, the plurality of weights corresponding to the plurality of prediction block candidates comprises: obtaining, by the decoder, a plurality of prediction block templates of the plurality of prediction block candidates as the plurality of templates; and obtaining, by the decoder, a current block template of the current block; and obtaining, by the decoder, the plurality of weights based on the plurality of prediction block templates and the current block template.

Example 15 includes the subject matter of example 2, wherein obtaining, by the decoder, the plurality of weights corresponding to the plurality of prediction block candidates further comprises: obtaining, by the decoder, the plurality of weights by using nonlocal mean filtering.

Example 16 includes the subject matter of example 15, wherein obtaining the plurality of weights by using the nonlocal mean filtering comprises: obtaining a plurality of distances based on the plurality of prediction block candidates and the current block; and obtaining the plurality of weights based on the plurality of distances and a strength of weighting.

Example 17 includes the subject matter of example 16, further comprising: determining, by the decoder, the strength of weighting by one of following steps: defining and fixing, by the decoder, a weighting strength candidate list comprising a plurality of typical weighting strength values; and selecting, by the decoder, a typical weight strength value as an optimal weighting strength value based on a flag signaled in a bitstream; receiving, by the decoder, an optimal weighting strength value signaled in a bitstream; obtaining, by the decoder, a plurality of prediction block templates of the plurality of prediction block candidates, obtaining, by the decoder, a current block template of the current block, and estimating, by the decoder, the strength of weighting based on the plurality of prediction block templates and the current block template; or estimating, by the decoder, the strength of weighting using a Quantization Parameter (QP) value and a variance of a current CU template of the current CU.

Example 18 includes the subject matter of example 1, wherein obtaining, by the decoder, the final prediction for the current block based on the plurality of prediction block candidates comprises: performing, by the decoder, singular value decomposition (SVD) on a matrix generated from the plurality of prediction block candidates; and obtaining, by the decoder, the final prediction based on results of performing the SVD.

Example 19 includes the subject matter of example 1, further comprising: receiving, by the decoder, a flag signaled in a bitstream, wherein the flag indicates whether a multi-hypothesis IBC mode is applied to the current block.

Example 20 includes the subject matter of example 19, further comprising: in response to determining that the flag indicates that the multi-hypothesis IBC mode is applied to the current block, receiving, by the decoder, an index signaled in the bitstream, wherein the index indicates a multi-hypothesis IBC method applied to the current block.

Example 21 includes the subject matter of example 1, further comprising: determining, by the decoder, multi-hypothesis IBC mode is applied to the current block based on coded information; wherein the coded information comprises at least one of following information: sum of absolute difference (SAD), sum of square error (SSE), Quantization Parameter (QP), neighbor prediction modes of the current block, or a slice type.

Example 22 includes a method for video encoding, comprising: obtaining, by an encoder, a plurality of prediction block candidates, wherein at least one of the plurality of prediction block candidates is coded based on an intra block copy (IBC) mode for a current block; obtaining, by the encoder, a final prediction for the current block based on the plurality of prediction block candidates; obtaining, by the encoder, the final prediction for the current block based on the IBC mode; and generating, by the encoder, a bitstream based on the final prediction.

Example 23 includes the subject matter of example 22, further comprising: obtaining, by the encoder, a plurality of weights corresponding to the plurality of prediction block candidates; and wherein obtaining, by the encoder, the final prediction for the current block based on the plurality of prediction block candidates comprises: obtaining, by the encoder, the final prediction for the current block based on the plurality of prediction block candidates and the plurality of weights.

Example 24 includes the subject matter of example 22, wherein obtaining, by the encoder, the plurality of prediction block candidates comprises: searching, by the encoder, a plurality of block candidates, wherein block vector (BV) matching costs of the plurality of the block candidates are lower than the BV matching costs of other block candidates; and selecting, by the encoder, the plurality of block candidates as the plurality of prediction block candidates.

Example 25 includes the subject matter of example 24, wherein the BV matching costs are measured with one of sum of absolute difference (SAD) or sum of square error (SSE).

Example 26 includes the subject matter of example 22, wherein obtaining, by the encoder, the plurality of prediction block candidates comprises: selecting, by the encoder, the plurality of block candidates based on a predefined mode; wherein the predefined mode comprises a planar mode.

Example 27 includes the subject matter of example 22, wherein obtaining, by the encoder, the plurality of prediction block candidates comprises: selecting, by the encoder, the plurality of block candidates based on a predefined mode of neighboring blocks; wherein the predefined mode of neighboring blocks comprises one of a top predefined mode or a left predefined mode.

Example 28 includes the subject matter of example 23, wherein obtaining, by the encoder, the plurality of weights corresponding to the plurality of prediction block candidates comprises: setting, by the encoder, each of the plurality of weights to be a reciprocal of an integer N, wherein N is a number of the plurality of prediction block candidates.

Example 29 includes the subject matter of example 23, wherein obtaining, by the encoder, the plurality of weights corresponding to the plurality of prediction block candidates comprises: deriving, by the encoder, the plurality of weights based on a plurality of block vector (BV) matching costs.

Example 30 includes the subject matter of example 29, wherein obtaining, by the encoder, the plurality of weights corresponding to the plurality of prediction block candidates further comprises: obtaining, by the encoder, a plurality of prediction BV matching costs of the plurality of prediction block candidates as the plurality of BV matching costs.

Example 31 includes the subject matter of example 29, wherein the plurality of BV matching costs are measured with one of sum of absolute difference (SAD) or sum of square error (SSE).

Example 32 includes the subject matter of example 23, wherein obtaining, by the encoder, the plurality of weights corresponding to the plurality of prediction block candidates further comprises: signaling, by the encoder, a block size of the current block or a syntax element that indicates the plurality of weights; wherein the syntax element is signaled in one of following levels: Sequence Parameter Set (SPS), Decoded Picture Set (DPS), Video Parameter Set (VPS), Supplemental Enhancement Information (SEI), Adaptation Parameter Set (APS), Picture Parameter Set (PPS), picture header (PH), slice header (SH), Region, Coding Tree Unit (CTU), Coding Unit (CU), Subblock, or Sample level.

Example 33 includes the subject matter of example 23, wherein obtaining, by the encoder, the plurality of weights corresponding to the plurality of prediction block candidates comprises: obtaining, by the encoder, the plurality of weights based on the plurality of prediction block candidates and the current block; and signaling, by the encoder, the plurality of weights in a bitstream.

Example 34 includes the subject matter of example 23, wherein obtaining, by the encoder, the plurality of weights corresponding to the plurality of prediction block candidates comprises: obtaining, by the encoder, the plurality of weights based on a plurality of templates.

Example 35 includes the subject matter of example 23, wherein obtaining, by the encoder, the plurality of weights corresponding to the plurality of prediction block candidates comprises: obtaining, by the encoder, a plurality of prediction block templates of the plurality of prediction block candidates as the plurality of templates; obtaining, by the encoder, a current block template of the current block; and obtaining, by the encoder, the plurality of weights based on the plurality of templates and the current block template.

Example 36 includes the subject matter of example 23, wherein obtaining, by the encoder, the plurality of weights corresponding to the plurality of prediction block candidates further comprises: obtaining, by the encoder, the plurality of weights by using nonlocal mean filtering.

Example 37 includes the subject matter of example 36, wherein obtaining, by the encoder, the plurality of weights by using the nonlocal mean filtering comprises: obtaining a plurality of distances based on the plurality of prediction block candidates and the current block; and obtaining the plurality of weights based on the plurality of distances and a strength of weighting.

Example 38 includes the subject matter of example 37, further comprising: determining, by the encoder, the strength of weighting by one of following steps: defining and fixing, by the encoder, a weighting strength candidate list comprising a plurality of typical weighting strength values, checking, by the encoder, the plurality of typical weighting strength values using rate distortion optimization; identifying, by the encoder, an optimal weighting strength value; and signaling, by the encoder, the optimal weighting strength value in a bitstream; obtaining, by the encoder, a plurality of prediction block templates of the plurality of prediction block candidates; obtaining, by the encoder, a current block template of the current block; and estimating, by the encoder, the strength of weighting based on the plurality of prediction block templates and the current block template; or estimating, by the encoder, the strength of weighting, using a Quantization Parameter(QP) value and a variance of a current block template of the current block.

Example 39 includes the subject matter of example 22, wherein obtaining, by the encoder, the final prediction for the current block based on the plurality of prediction block candidates comprises: performing, by the encoder, singular value decomposition (SVD) on a matrix generated from the plurality of prediction block candidates; and obtaining, by the encoder, the final prediction based on results of performing the SVD.

Example 40 includes the subject matter of example 22, further comprising: signaling, by the encoder, a flag in a bitstream, wherein the flag indicates whether a multi-hypothesis IBC mode is applied to the current block.

Example 41 includes the subject matter of example 40, further comprising: under condition that the flag indicates that the multi-hypothesis IBC mode is applied to the current block, signaling, by the encoder, an index in the bitstream, wherein the index indicates a multi-hypothesis IBC method applied to the current block.

Example 42 includes the subject matter of example 22, further comprising: determining, by the encoder, that multi-hypothesis IBC mode is applied to the current block based on coded information; wherein the coded information comprises at least one of following information: sum of absolute difference (SAD), sum of square error (SSE), Quantization Parameter (QP), neighbor prediction modes of the current block, or a slice type.

Example 43 includes an apparatus for video decoding, comprising: one or more processors; and a memory coupled to the one or more processors and configured to store instructions executable by the one or more processors and a bitstream, wherein the one or more processors, upon execution of the instructions, are configured to perform the method in any one of examples 1-21 with the bitstream.

Example 44 includes an apparatus for video encoding, comprising: one or more processors; and a memory coupled to the one or more processors and configured to store instructions executable by the one or more processors, wherein the one or more processors, upon execution of the instructions, are configured to perform the method in any one of examples 22-42 to generate a bitstream and to store the bitstream in the memory.

Example 45 includes a non-transitory computer-readable storage medium for storing computer-executable instructions that, when executed by one or more computer processors, cause the one or more computer processors to perform the method in any of examples 1-21.

Example 46 includes a non-transitory computer-readable storage medium for storing computer-executable instructions that, when executed by one or more computer processors, cause the one or more computer processors to perform the method in any of examples 22-42.

Example 47 includes a non-transitory computer-readable storage medium for storing a bitstream to be decoded by the method in any of examples 1-21.

Example 48 includes a non-transitory computer-readable storage medium for storing a bitstream generated by the method in any of examples 22-42.

What is claimed is:

1. A method for decoding video data, comprising:
determining a reference block in a video frame from a bitstream for predicting a current block in the video frame;
obtaining a set of filter coefficients corresponding to a filter shape based on sample values from both a training area associated with the reference block and a training area associated with the current block;
deriving, with the set of filter coefficients and the filter shape, each of predicted sample values of the current block based on a plurality of corresponding sample values associated with the reference block; and
reconstructing the current block based on the predicted sample values.

2. The method of claim 1, wherein deriving each of predicted sample values of the current block comprises:
deriving each of predicted luma sample values of the current block based on a plurality of corresponding luma sample values associated with the reference block; or
deriving each of predicted chroma sample values of the current block based on a plurality of corresponding chroma sample values associated with the reference block.

3. The method of claim 1, wherein deriving each of predicted sample values of the current block comprises:
performing convolution operation on the set of the filter coefficients and the plurality of corresponding sample values to derive a result of the convolution operation, and
deriving each of the predicted sample values based on the result of the convolution operation and a reference sample value associated with the current block.

4. The method of claim 3, wherein
the plurality of corresponding sample values comprise one or more sample values represented as one or more of a plurality of sample values associated with the reference block reduced by the reference sample value respectively; or
the plurality of corresponding sample values comprise one or more sample values represented as a square of one or more of a plurality of sample values associated with the reference block reduced by the reference sample value respectively.

5. The method of claim 3, wherein the reference sample value is the sample value of a top-left sample adjacent to the current block.

6. The method of claim 1, wherein the training area associated with the reference block comprise N lines above and/or left to the reference block, and the training area associated with the current block comprise N lines above and/or left to the current block, wherein N is an integer.

7. The method of claim 1, wherein the training area associated with the reference block is non-adjacent to the reference block, and the training area associated with the current block is non-adjacent to the current block.

8. The method of claim 1, further comprising:
deriving each of predicted sample values of the current block based on a plurality of corresponding sample values associated with at least one second reference block in the video frame; and
reconstructing the current block by applying weighting factors for the predicted sample values.

9. The method of claim 8, further comprising obtaining information for one or more coding levels indicating at least one of:
the filter shape;
a template area of the reference block;
the template area of the current block;
whether to use inherited filter coefficients from a previously decoded block;
the filter coefficients inherited from the previously decoded block; or
the weighting factors.

10. A method for encoding video data, comprising:
determining a reference block in a video frame for predicting a current block in the video frame;
obtaining a set of filter coefficients corresponding to a filter shape based on sample values from both a training area associated with the reference block and a training area associated with the current block;
deriving, with the set of filter coefficients and the filter shape, each of predicted sample values of the current block based on a plurality of corresponding sample values associated with the reference block; and
generating a bitstream based on the predicted sample values.

11. The method of claim 10, wherein deriving each of predicted sample values of the current block comprises:
deriving each of predicted luma sample values of the current block based on a plurality of corresponding luma sample values associated with the reference block; or
deriving each of predicted chroma sample values of the current block based on a plurality of corresponding chroma sample values associated with the reference block.

12. The method of claim 10, wherein deriving each of predicted sample values of the current block comprises:
performing convolution operation on the set of the filter coefficients and the plurality of corresponding sample values to derive a result of the convolution operation, and
deriving each of the predicted sample values based on the result of the convolution operation and a reference sample value associated with the current block.

13. The method of claim 12, wherein
the plurality of corresponding sample values comprise one or more sample values represented as one or more of a plurality of sample values associated with the reference block reduced by the reference sample value respectively; or
the plurality of corresponding sample values comprise one or more sample values represented as a square of one or more of a plurality of sample values associated with the reference block reduced by the reference sample value respectively.

14. The method of claim 12, wherein the reference sample value is the sample value of a top-left sample adjacent to the current block.

15. The method of claim 10, wherein the training area associated with the reference block comprise N lines above and/or left to the reference block, and the training area associated with the current block comprise N lines above and/or left to the current block, wherein N is an integer.

16. The method of claim 10, wherein the training area associated with the reference block is non-adjacent to the reference block, and the training area associated with the current block is non-adjacent to the current block.

17. An electronic apparatus, comprising:
a non-transitory computer readable medium; and
a processor, configured to store a bitstream to be decoded by the decoding method according to claim 1.

18. An electronic apparatus, comprising:
a non-transitory computer readable medium; and
a processor, configured to store a bitstream generated by the encoding method according to claim 10.

19. A method for storing a bitstream, comprising:
performing the encoding method according to claim 10 to generate a bitstream; and
storing the bitstream.

20. Anon-transitory computer readable storage medium storing a bitstream generated by a method for encoding video data, wherein the method comprises:
determining a reference block in a video frame for predicting a current block in the video frame;
obtaining a set of filter coefficients corresponding to a filter shape based on sample values from both a training area associated with the reference block and a training area associated with the current block;
deriving, with the set of filter coefficients and the filter shape, each of predicted sample values of the current block based on a plurality of corresponding sample values associated with the reference block; and
generating a bitstream based on the predicted sample values.
